(19) United States
(12) Patent Application Publication
(10) Pub. No.: US 2008/0020362 A1
(43) Pub. Date: Jan. 24, 2008

(54) Methods and Apparatus for Simulaton of Endovascular and Endoluminal Procedures

(76) Inventors: Stephane M. Cotin, Belmont, MA (US); Xunlei Wu, Winthrop, MA (US); Paul F. Neumann, Boston, MA (US); Julien R. Lenoir, Roellecourt (FR); Christian M. Duriez, Lille (FR); Rayn S. Bradsley, Grafton, MA (US); Vincent Pegoraro, Salt Lake City, UT (US); Steven M. Dawson, Carlisle, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/573,109

(22) PCT Filed: Aug. 10, 2005
(86) PCT No.: PCT/US05/28594

§ 371 Date: Feb. 2, 2007

Related U.S. Application Data
(60) Provisional application No. 60/600,188, filed on Aug. 10, 2004.

(51) Int. Cl. G09B 23/30

(52) U.S. Cl. 434/267

(57) ABSTRACT

Methods and apparatus provide realistic training in endovascular and endoluminal procedures. One embodiment includes modeling accurately the tubular anatomy of a patient to enable optimized simulation. One embodiment includes simulating the interaction between a flexible device and the anatomy and optimizing the computation. One embodiment includes replicating the functionality of therapeutic devices, e.g. stents, and simulating their interaction with anatomy. One embodiment includes computing hemodynamics inside the vascular model. One embodiment includes reproducing visual feedback, using synthetic X-ray imaging and/or or visible light rendering. One embodiment includes generating contrast agent injection and propagation through a tubular network. One embodiment includes reproducing aspects of the physical environment of an operating room by simulating or tracking, such as C-arm control panel, foot pedals, monitors, real catheters and guidewires, etc. One embodiment includes tracking instrument position and mimicking haptic feedback experienced when manipulating certain medical devices.

### FIELD OF THE INVENTION

The present invention relates to medical training and, more particularly, to devices and systems for providing realistic training in endovascular and endoluminal procedures.

### BACKGROUND OF THE INVENTION

As is well known in the art, over the last thirty years medicine has been revolutionized by the advent of minimally invasive techniques to treat disease without the need for surgery. Among the most widely practiced of these new minimally invasive procedures are interventional vascular and visceral procedures and flexible endoscopy. These interventional procedures such as balloon dilatation of strictures, stenting, and catheter-based drug delivery have substantially improved the outcomes for patients with various diseases.

In flexible endoscopy, entry is made through a natural orifice or a small surgical incision. Interventional fluoroscopic procedures are initiated via a percutaneous puncture in which a guidewire-catheter combination is inserted and advanced under fluoroscopic guidance. The fluoroscope emits X-rays generating a continuous series of images on the procedure room monitors showing the location of the guidewire and catheter within the patient. The fluoroscope is frequently attached by a C-arm that has two degrees of freedom in movement around a patient and is controlled with a joystick and/or foot pedals. The figure below shows a typical room for interventional radiology procedures.

FIG. 1A shows a typical interventional radiology operating room and FIG. 1B shows an actual fluoroscopic image showing a catheter inside a patient. Unfortunately, the tubular structures themselves are not visible in X-ray images. To see them and their flow patterns, iodine-based contrast agents are injected through the catheter to highlight a patient's anatomy. By analyzing these images, interventionalists can define the abnormal areas, select the proper instruments, and verify the success or failure of treatment. Treatment options can include reducing flow, augmenting flow or delivering drugs, for example. Because treatment is delivered directly within the closed body, using only image-based guidance, the dedicated skill of instrument navigation and the thorough understanding of vascular and visceral anatomy serve to avoid devastating complications which could result from poor visualization or poor technique.

Interventionalists, physicians and others who specialize in these minimally invasive, image-guided techniques, require extensive training periods to attain competency. Conventional training often uses animal models and then progresses on patients under the supervision by a certified interventionist. Mistakes naturally occur during this learning process putting patients at risk. It is believed that 1) there is a need for specialty-specific training, 2) competency is directly related to the number of interventions performed, and 3) it is very challenging to meet the training requirements while at the same time protecting patients from untrained practitioners.

Similar techniques are used to perform endoscopic procedures within hollow organs such as the bowel, biliary tree, airways, urinary tract, and the fluid filled structures of the skeletal and central nervous systems. In these uses, a long flexible endoscope is used to navigate through complex or tortuous anatomic structures with either video or fluoroscopic guidance, allowing eventual delivery of some therapeutic agent or device. The principles of navigation and intervention between these two domains are similar, including many of the same catheter/guidewire combinations, balloons and stents. Training programs for these endoscopic procedures follow a similar pattern to the methods described previously for interventional procedural training.

### BRIEF DESCRIPTION OF THE DRAWINGS

The exemplary embodiments contained herein will be more fully understood from the following detailed description taken in conjunction with the accompanying drawings, in which:

FIG. 1A is a prior art pictorial representation of a typical interventional Radiology operating room;

FIG. 1B is a prior art pictorial representation of a fluoroscopic image showing a catheter inside a patient;

FIG. 2 is a block diagram of a surgical procedure similar system in accordance with the present invention;

FIG. 3 is a pictorial representation of a tubular structure having a medial axis in accordance with the present invention;

FIG. 4 is a pictorial representation of parent branch selection in accordance with the present invention;

FIGS. 5a-d show incorrect connections produced in some conventional representations;

FIG. 6 is a pictorial representation of a bifurcation reconstructed in accordance with the present invention;

FIG. 6A is a diagram showing steps in collision detection;

FIG. 7 is a diagrammatic depiction of a substructure and sub-substructure;

FIG. 8A is a textual representation of an exemplary implementation of force accumulation;

FIG. 8B is a textual representation of an exemplary implementation of displacement;

FIG. 9a is a pictorial representation of setting boundary conditions and FIG. 9b shows relaxing boundary conditions;

FIGS. 10a-c show settings for respective limit values;

FIG. 11 is a schematic depiction of an exemplary deformable device model;

FIG. 11a is a schematic depiction of beam deformation and FIG. 11b shows local deformation;

FIG. 12 is a diagram showing exemplary process steps implementing collision response;

FIGS. 13a and 13b are pictorial representations of artificial boundaries;

FIGS. 14a-d are pictorial representations of collision processing;

FIGS. 15a-c are pictorial representations of catheter navigation inside a cerebrovascular network with collision detection and response in accordance with the present invention;

FIG. 16 is a schematic depiction of a process for computation, deformation, and navigation of a virtual device inside a virtual representation of anatomy;

FIG. 17 shows an exemplary process of volume rendering for simulating images directly from a volume dataset;

FIGS. 17a, b, c are images of volume rendering for polygon slices, 3D texture, and final image, respectively;

FIGS. 18a, b are synthetic X-ray images generated from a CT scan of a head;

FIG. 19 is an image of simulated digital subtraction angiography based on 2D texture blending;

FIGS. 20a and 20b are images showing examples of combined X-ray and visible light rendering: FIG. 20a shows the arterial side of the vascular network and FIG. 20b shows vessels and blood pressure;

FIG. 21 is a flow diagram showing a computation process simulating the propagation of contrast agent in a vascular model;

FIG. 22 is a pictorial representation of contrast agent concentration;

FIGS. 23a-c show for sampling points along a medial axis mapping to a set of voxels defining the volume of the tubular structure;

FIG. 24 is a pictorial representation of a tracking system for a flexible instrument providing haptic feedback; and

FIGS. 24a-f are schematic depictions of features of the tracking system of FIG. 24.

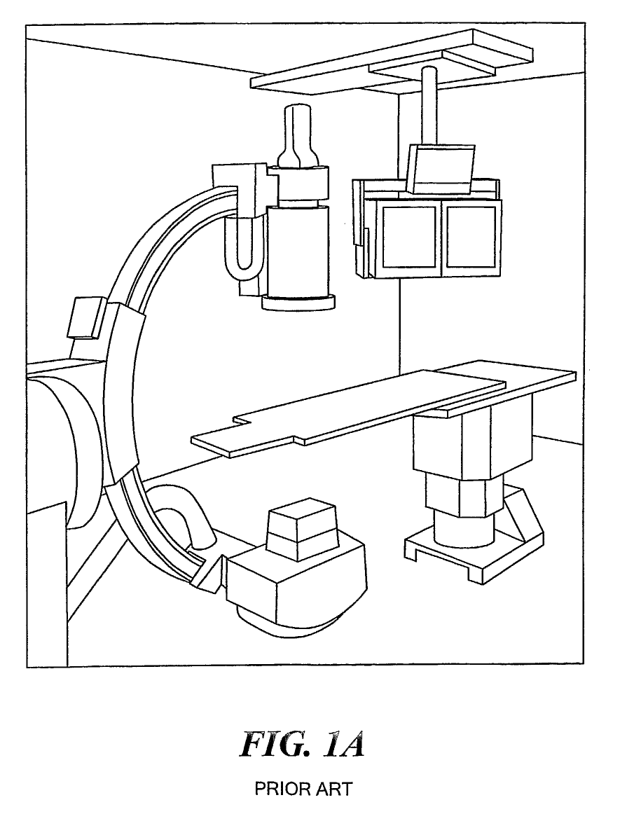

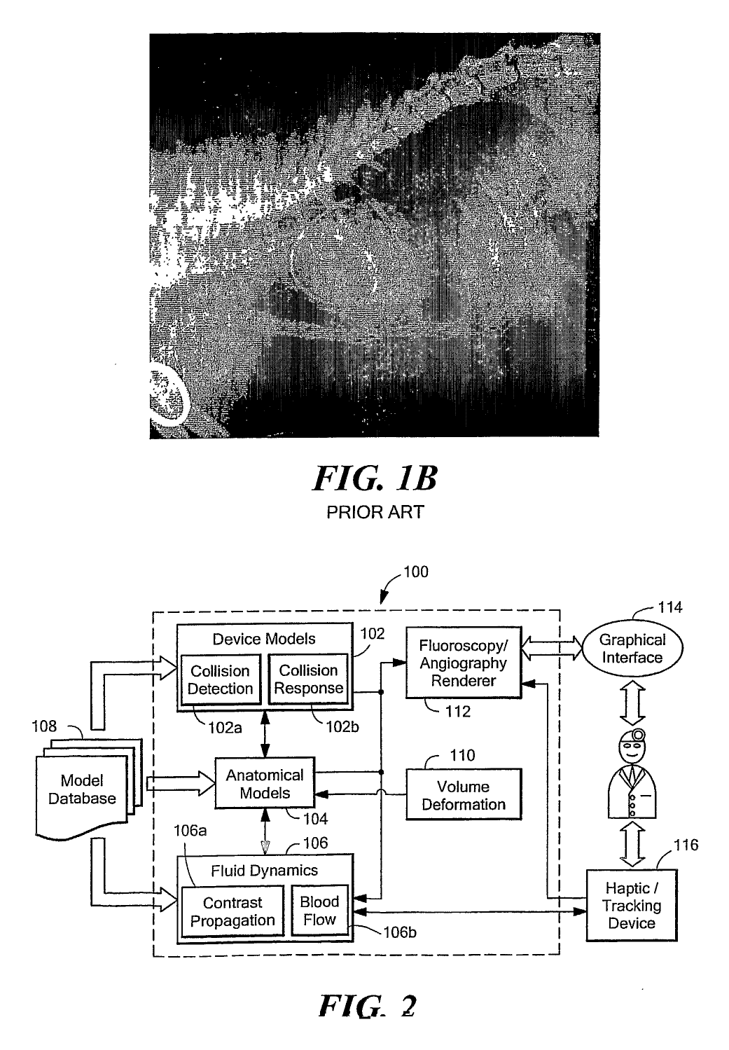

### SUMMARY

In general, the present invention provides methods and apparatus for real-time computer-based simulation of vascular or visceral therapy and/or endoscopic surgery, which can be useful for training in these procedures. Various embodiments and features of the invention can include one or more of:
Modeling accurately the anatomy of a patient, in particular tubular anatomical structures, in such a way that it enables optimized simulation
Simulating with accuracy the interaction between a flexible device (such as a catheter, a guidewire, or an endoscope) and the anatomy and optimizing the computation for real-time operation
Replicating the functionality of the associated therapeutic devices, e.g. stents, balloon catheter, coils, and simulating in real-time their interaction with the anatomy
Computing accurate hemodynamics inside the vascular model, including the changes induced by the therapy or the procedure
Reproducing visual feedback, either using synthetic X-ray imaging or visible light rendering, with a high level of fidelity
Generating realistic contrast agent injection and propagation through a tubular network
Reproducing aspects of the physical environment of an operating room by simulating or tracking, such as C-arm control panel, foot pedals, monitors, real catheters and guidewires, syringes, patient vital signs
Tracking the instrument position and mimicking the haptic feedback experienced when manipulating certain medical devices

In one aspect of the invention, a system provides a real-time computer-based simulation of vascular therapy applicable to various interventional radiology procedures. It is understood that the invention is broadly applicable to interventional therapies in general based upon percutaneous access for flexible instruments with intracorporeal navigation. One goal of the inventive system is to replicate the operating room experience as closely as possible by duplicating the interface with actual equipment, including tracking catheters/guidewires/injections, and simulating the interactive fidelity of fluoroscopic images of the human anatomy with pathologic states.

Various features of the invention embodiments include catheter and guidewire finite element models, real-time one-dimensional fluid dynamics of blood flow, volumetric contrast agent propagation, high-fidelity synthetic fluoroscopic and angiographic images, and a robust compact tracking interface. In one embodiment, these components are developed and integrated into an interventional procedural training system. An educational curriculum including a library of pathologically relevant cases, a tutorial, and a set of metrics for performance assessment is formulated as well. The simulator can be optimized for real-time performance on an affordable personal computer platform. This will permit students to learn and err on a computer, so that interventional procedures are safer and faster.

### DESCRIPTION OF THE INVENTION

FIG. 2 is a block diagram of an exemplary interventional radiology procedure training system 100 in accordance with the present invention. The system includes a device model module 102 having a collision detection module 102a and collision response module 102b for a simulated procedure. An anatomical model module 104 models patient anatomy. And a fluid dynamics module 106 includes a contrast propagation module 106a and blood flow module 106b. A model database 108 can provide information to the device model module 102, anatomical model module 104, and fluid dynamics module 106. Volume deformation module 110 can provide information to the anatomical model module 104 and a fluoroscopy/angiography renderer 112 can provide information needed to display information to a user.

A graphical interface 114 can be provided to enable a user to interact with the system and a haptic/tracking device 116 for various instruments can be coupled to the system, as described more fully below.

In one aspect of the invention, a hollow lumen structure, such as a structure in the human body, is described using a multi-representation model that permits a consistent and optimized representation of (part of) the circulatory, gastrointestinal, biliary, urinary, skeletal, nervous and/or respiratory system. It will be appreciated that other anatomical structures can also be described. This multi-representation model also provides support to certain simulation components, as described below.

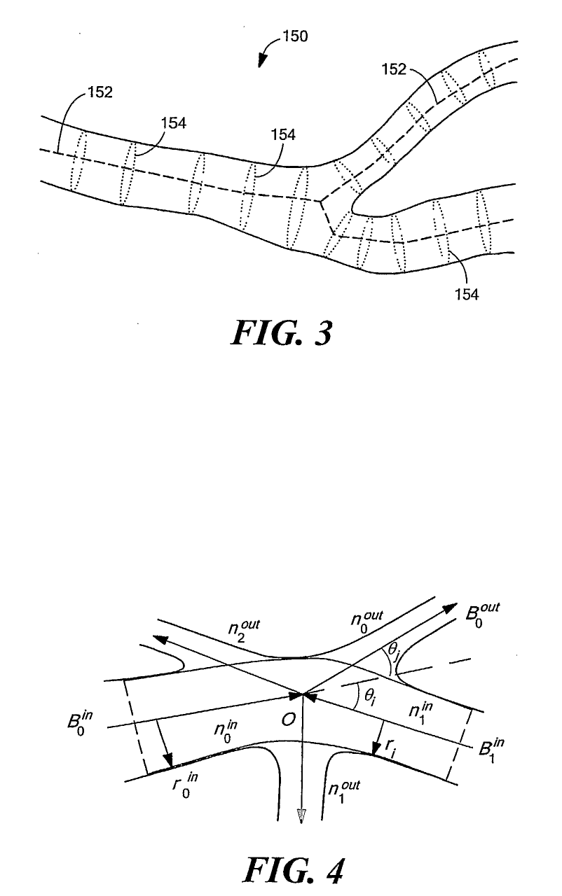

As shown in FIG. 3, an anatomical structure 150 can be modeled, i.e., mathematically approximated. Within the human body, several anatomical systems have, in general, a lumen tree-like shape such as the vascular, gastrointestinal or respiratory systems. Also, several organs have a tubular structure.

In an exemplary embodiment, initially a central path (or medial axis) 152 is defined through the center of the structure. Medial axes can be extracted from patient medical imaging scans with imaging processing algorithms, drawn by artists using three-dimensional modeling software, generated by statistical algorithms or synthesized though a combination of these techniques. Other techniques are also possible. A set of planar cross sections 154 orthogonal to the medial axes is created, describing a thin boundary slice through the structure exterior wall. Cross sections can also be constructed or extracted through a similar process as the medial axes and can be approximated by a circular or elliptical shape.

Describing a structure using a medial axis provides a number of advantages. For example, a smooth continuous bounding surface can be defined in the direction of the medial axis through the cross section boundaries. In addition, medial axes support the computation of information throughout the tubular anatomy, for instance, one-dimensional blood flow computation, using a connectivity graph derived from the medial axis representation, and contrast agent propagation computation using a set of sample points distributed along the medial axis. Further, medial axis representations provides a path that can be followed by devices such as catheters or guidewires when navigating through narrow structures, thus reducing the computational requirements for collision detection and collision response. Also, information, such as tissue properties, can be embedded and referenced along the medial axis.

As described above, hollow lumen structures can be described using a set of medial axes and series of cross sections. When the structure has a tree-like topology, it can also be described using a graph of medial axes and a series of cross sections. An enclosing surface can be generated which approximates the structure exterior or interior boundary.

In accordance with embodiments of the invention, a surface reconstruction method can generate a surface representation that is continuous (no holes or discontinuities), is smooth (surface normals are continuous) and requires a minimal number of surface elements to describe it. In addition, the surface model can accurately model regions where different tubular structures intersect, such as bifurcations for instance.

With such a representation, efficient collision detection and/or collision response algorithms can be developed; stable vessel deformation and real-time flow simulation can be performed, as well as multi-scale anatomical visualization. The inventive representation technique provides advantages over some known method in various exemplary areas:

Handling Directed Graphs with Loops and Multiple Roots:

One branch is allowed to have multiple parents and children. Tubular structures can form loops, e.g. circle of Willis. One branch can connect to a single branch forming a “1-furcation” as well. This is useful to construct a unified directed graph for multiple hollow lumen structures, both arterial and venous sides, for instance. Multiple trees can be reconstructed at the same time.

Parent Branch Selection Based on Angle and Radii Variance:

To patch the surface at vessel joints, the inventive algorithm defines at a parent branch with respect to the current branch and forms polygons to connect the parent surface and other joint branches' base meshes. Referring to FIG. 4, since nᵢ, the cross section normal at the beginning or end of branch Bᵢ, is computed by differentiating neighboring sampling points, the approximation can be misleading when centerlines are under sampled. The inventive scheme considers both branching angle and vessel radii to reduce under-sampling artifacts which in turn improves the reconstruction robustness. First, nᵢⁱⁿ where i>0 are reversed. Then, one computes the disparity Ω≡λθᵢ+(1−λ)|rᵢ−rⁱⁿ₀|, where λε[0,1] is the weight balancing the influence of branching angle and that of the average radii variance. The algorithm selects the branch with minimal Ω as the parent branch.

Adaptive Cross Sections Distribution:

The cross section distribution scheme considers both radii and centerline curvature as set forth below in Equation 1:

$${x}_{i + 1} - {x}_{i} = α ( \frac{{r}_{i + 1}}{1 + {βκ}_{i + 1}} + \frac{{r}_{i}}{1 + {βκ}_{i}} ) i ∈ [ 0 , {N}_{segment} - 1 ] \qquad Eq . ( 1 )$$

where xᵢ is the curvilinear coordinate of the cross section center. rᵢ and Kᵢ are the corresponding radius and Gaussian curvature, respectively, obtained by linear interpolation between two adjacent initial samples points where α>0 is the desired spacing scalar and β>0 is the weight on curvature influence. After filtering, the centers of two adjacent cross sections are placed closer if the vessel is thin or turns. A straight branch does not need many cross sections to resemble its original geometry.
Robust Joint Tiling:

In one embodiment, the inventive technique connects every branch to its parent using both end segments regardless of the branching angles so that a single recursive joint tiling is needed. This technique can be referred to as “end-segment-grouping” unifying all the outgoing branches together such that the connecting patches connect the bottom of the outgoing branch's base mesh with both end segments of parent branches.

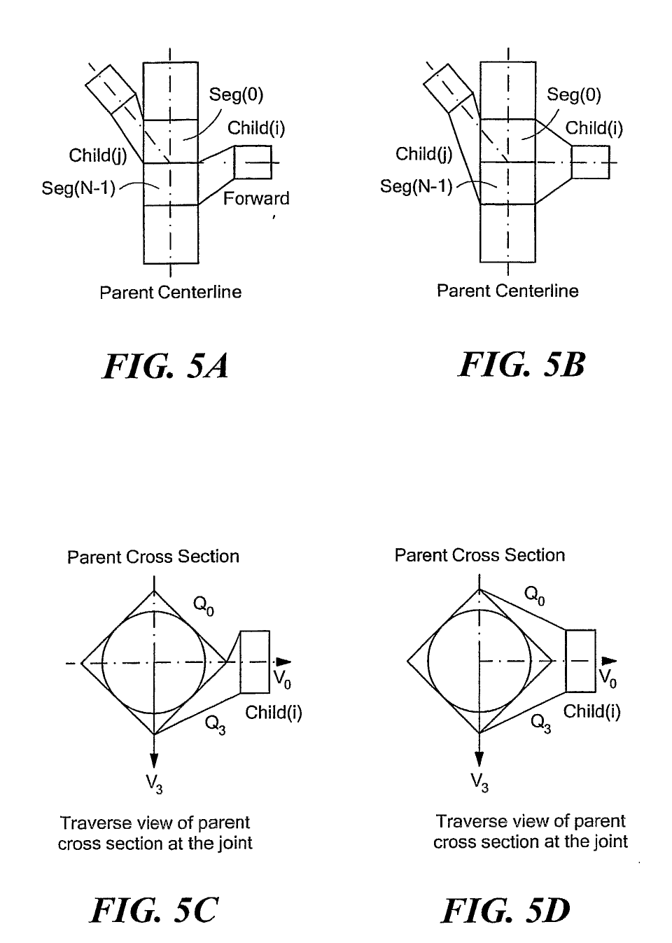

Without the inventive method, incorrect connections can be created using conventional techniques as shown in FIGS. 5a-d. The inventive approach can also reduce the bottle-neck effect and eliminate twisting artifacts as shown in FIGS. 5b and 5d. More particularly, when the outgoing centerline forms a small angle with the parent centerline, using a single end segment produces bottle-neck effect (FIGS. 5a, 5c). The artifact is reduced when both end segments are used for the joint tiling. When the outgoing centerline lies in or close to the bisection plane of two parent centerlines, using a single end segment loses the symmetry. This symmetry is nicely preserved by connecting the mesh of Child(i) to the same sides of Seg(N−1) and Seg(0). End-segment-grouping not only reduces the patching artifacts in both extreme cases, but yields smoother parent-to-branch transition under all branching configuration.

The following pseudo-code algorithm illustrates an exemplary implementation of recursive joint tiling, i.e., the analysis of the medial axis orientation and the creation of a tile that will generate a minimally twisted surface.

```
Tile_Bifurcation(Base_Polygon, Segment, Branch)
    Inverse Segment direction due to graph connectivity.
    if (Segment intersects Base_Polygon)
        if (Intersection close to the edge of Base_Polygon)
Base_Polygon = Expand(Base_Polygon);
        //Form a new polygon without overlap edges.
            Base_Polygon = Form_Polygon(Base_Polygon,
Segment_Tetragon);
            Branch = Current Segment's hosting branch.
            Tile_Bifurcation(Base_Polygon, Next_Segment, Branch);
            else //No inersection
        if (None of the connected Segments intersects Base_Polygon)
        Form_Min_Twisted_Patch(Base_Polygon,
        Segment_Tetragon);
        Tile_Bifurcation(Base_Polygon, Next_Segment, Branch);
end
```

In a further aspect of the invention, improvements in joint tiling are not just done in the parent centerline direction. Another method, called “adjacent-quadrant-grouping” uses two adjacent sides of the end hexahedron segments. When a child centerline lies close to the boundary of two quadrants, tiling with only one quadrant introduces twists. This artifact is eliminated by adding the neighboring quadrant into the tiling, e.g. Q₀ and Q₃ are grouped together as a whole when tiling Child(i) to the parent mesh (FIG. 5a-d). When Child(i) lies close to a quadrant center, the inventive method uses only current quadrant for tiling in an exemplary embodiment.

Using the above techniques, an exemplary reconstruction scheme is able to handle generic medial axis sets, assuming they are represented as directed graphs. It is less prone to artifacts due to initial data sampling. It is also more robust to model any type of branching pattern. The reconstructed smooth vascular surface is suitable for the purpose of efficient and stable physics modeling, and smooth visualization.

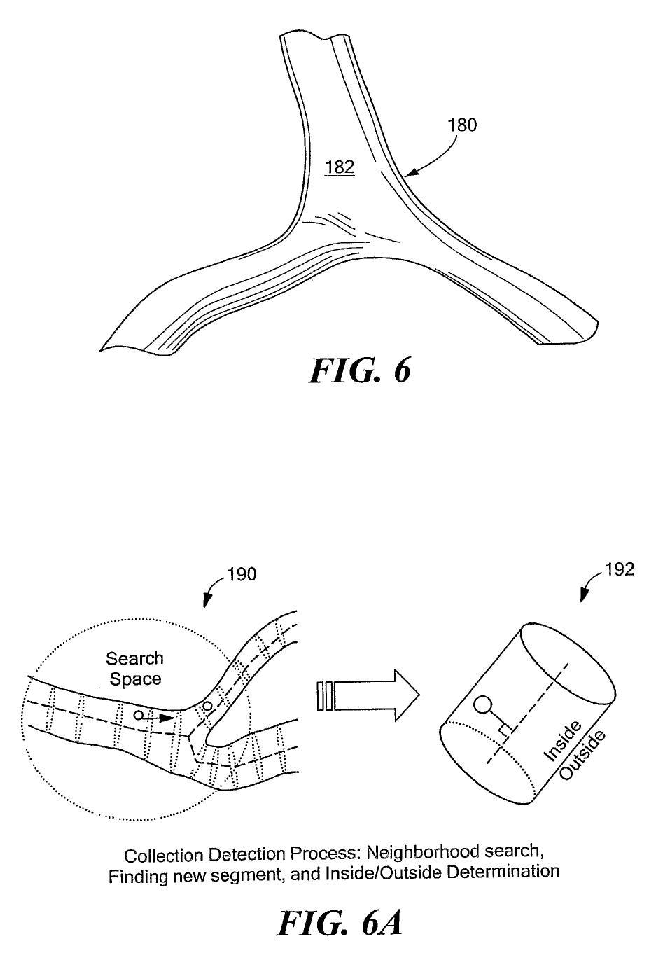

FIG. 6 shows an exemplary bifurcation image 180 created using an exemplary embodiment of the inventive reconstruction method. The reconstructed surface 182 is smooth yet uses a minimal number of surface elements to provide efficient rendering and collision detection with medical devices.

In another aspect of the invention, the inventive simulation technique includes collision detection. In one embodiment, simulating the navigation through (a network of) tubular structures requires a tracking device in which actual instruments can be inserted, and a method for detecting contacts between the virtual representations of the anatomy and the medical device(s). While there are many approaches to the “classic” problem of collision detection (i.e. two objects moving toward each other collide), the inventive technique addresses in the case of (flexible) devices moving through anatomical tubular structures. Contact between the two objects is associated with a sliding condition, i.e., the angle between the path of one object and the surface normal of the other object at the point of contact is shallow. Moreover, when sliding occurs, the occurrences of contact are numerous, thus an optimal collision detection method is desirable.

To optimize the collision detection process it is assumed that the model of a device is a discretization of the real device, and that this discretization includes a set of points (or nodes) and other geometric primitives. Each device node is then mapped to a corresponding segment of the lumen model that it resides within. As shown in FIG. 6A, the collision detection algorithm includes a series of steps: step 190 searching the neighborhood of the current segment associated with a device node for the node's new segment, an intersection test to determine which segment the device node now resides in and step 192 returning a value defining whether the node is outside or inside the surface of the segment. To determine in an optimal manner in which segment a given node/point is located, the search is reduced from a space to a subset of only a few segments centered about the previous segment containing the node. The projection of the node onto the medial axis of the subset of segments is then computed. From the parametric coordinates of the projection on the medical axis one can then determine the segment containing the node at the current time step. The size of the local search space is a function of the speed at which the device is advanced through the lumen. In most cases, since medical devices are inserted slowly through a lumen structure, only a very small neighborhood of segments needs to be searched to determine the new segment that a device node has moved within.

Once the new segment associated with a device node has been determined, then an intersection test with the segment's surface elements is performed. If the device node is found to be outside, then a collision response module will integrate this information to compute the next configuration of the device and the tubular structure.

The surface representation is also processed to partition the list of surface elements into convex and non-convex (concave) sets. If surface elements are planar, this is a necessary step when computing the interaction between a flexible device and the surface of the lumen, as described further below.

Once a surface of the tubular structure has been defined, the volume defined by the surface can also be approximated by a set of volume elements. This can also be done for instance using Finite Element primitives such as tetrahedra, for computing complex flow of soft tissue deformation. Volume elements can also represent the density or concentration of gas or fluid within the lumen structure, and can be composed of space filling primitives such as spheres, cubes, or more generically voxels.

In general, the inventive multi-representation anatomical model of hollow lumen structures includes a graph of medial axes with corresponding cross sectional boundaries, a surface composed of surface elements which approximate the boundary of the structure, and a set of volume elements which define the interior space. For efficiency, the model is subdivided into small local regions so that a minimum number of entities need to be searched and processed for a desired operation. These local model regions will be called segments and they are defined as the space between two adjacent cross sections. Segments will include a section of the medial axis, a set of surface elements delimitated by the two cross sections, and also a discretized representation of the volume defined by the two cross sections and the local surface. Thus, the entire model can be visualized as a list of neighboring segments. At joint regions where several branches split, there will be overlap between neighboring segments so multiple segments will be searched in these regions. Base operations on segments can be, but are not limited to: collision detection and collision response based on enclosing surface element, fluid dynamics based on medial axis length, cross section and density distribution through the voxel elements, and fixed tracking on device models along medial axis within narrow branches.

In a further aspect of the invention, a technique is provided for real-time simulation of non-linear deformations of wire-like structures under a large number of holonomic or non-holonomic constraints, and the definition of such constraints to confine the flexible device inside a tubular shaped structure. Examples of this include (but are not limited to) catheters, guidewires, stents, coils, and flexible endoscopes. One of ordinary skill in the art will appreciate that providing realism on relatively affordable hardware while maintaining real-time computation is a desirable aspect of medical simulation.

To control the motion of a flexible device (catheter, guidewire or endoscope, for instance) within the tubular anatomy, the physician can only push, pull or twist the proximal end of the device. Since such devices are constrained within the patient's anatomy, it is the combination of input forces and contact forces that allow them to be moved toward a target. The main characteristics of wire-like structures that an ideal model should try to replicate include geometric non-linearities, high tensile strength and low resistance to bending.

In an exemplary embodiment, such devices are modeled as a finite set of linearly elastic beam elements. The choice of beam elements for modeling devices such as catheters, guidewire, endoscopes or even coils, is natural since beam equations include cross-sectional area, cross-section moment of inertia, and polar moment of inertia, allowing solid and hollow devices of various cross-sectional geometries and mechanical properties to be modeled. One issue of this model is its limited ability at representing the large geometric non-linearities of the catheter or guidewire that occur during navigation inside the vascular network. In one embodiment, a method allows for highly non-linear behavior while providing real-time performance. Additional optimizations based on substructure analysis are also added to the initial beam model to permit even faster computation times, for interactive navigation with haptic feedback.

To model the deformation of a catheter guidewire, a representation is based on three-dimensional beam theory, where the elementary stiffness matrix Ke is a 12×12 symmetric matrix that relates angular and spatial positions of each end of a beam element to the forces and torques applied to them. A description of the local stiffness matrix [Ke] for a linear elasticity formulation is well known in the art. For the entire structure describing a catheter or guidewire, the global stiffness matrix [K] is computed by summing the contributions of each element, thus leading to the following equilibrium equation in the quasi-static case:
[K]U=F
where [K] is a band matrix due to the serial structure of the model (one node is only shared by one or two elements), and U represents a column matrix of displacements corresponding to external forces F. The matrix [K] is singular unless some displacements are prescribed through boundary conditions. Such boundary conditions are naturally specified by setting the first node of the device (base node) to a particular translation or rotation imposed by the user. There is, however, a drawback in using directly such a model: it is linear and therefore cannot represent the geometric non-linearities that a typical wire-like object exhibits.

In an exemplary embodiment, the system updates [Ke] at every time step, by using the solution obtained at the previous time step. The new set of local stiffness matrices are then assembled in [Kt]. Here, the initial configuration is not used as the reference state, but instead the previously computed solution is used. By controlling when each new [Kt] is going to be computed, one can ensure one remains in the linear domain for each incremental step, leading to a correct, global deformation. One potential drawback of this approach is that the model could exhibit an inelastic behavior, i.e. in the absence of forces or torques, the model would only return to the previous state, not the reference configuration. This problem can be overcome by computing a force Ft defined as Ft=−λ[Kt](Xt−X0) with 0<λ≦1. This force is added to the external forces F before solving the linear system, and it can be shown that it acts as a damping force, where a relates to the damping coefficient of the model.

To simulate accurately a device such as a guidewire, a catheter or an endoscope, one needs to have a large number (e.g., several hundreds) of beam elements in the model. Although solving large linear systems can be done in near real-time using iterative methods, real-time computation on a standard workstation is no longer possible when integrating non-holonomic constraints. To improve speed and handle accurately collision response, optimizations can be used as described below.

To optimize the computation of a wire-like object composed of multiple beam elements, one can decompose the object in a set of substructures. Each substructure can be constituted of one or several beam elements, and is analyzed independently, assuming that all common boundaries (joints) with the adjacent substructures are fixed. By doing this, each substructure is isolated from the rest of the model. In a second phase, the boundary conditions are relaxed by propagating from the base to the tip of the catheter. The actual local compliance is determined from equilibrium equations at each boundary joint. The total deformation of the structure can be calculated from the superposition of two computations (one with boundaries fixed, which isolate every structure, allowing a good reducing of computation, and an other computation for correcting the first one by relaxing the boundaries)
[U]=[U^{(α)}]bdfixed+[U^{(β)}]correction
[F]=[F^{(α)}]bdfixed+[F^{(β)}]correction
Nodes are also split into two categories: boundary nodes and internal nodes.

$$[ \begin{matrix}{F}_{i} \\ {F}_{b}\end{matrix} ] = [ \begin{matrix}{K}_{ii} & {K}_{ib} \\ {K}_{bi} & {K}_{bb}\end{matrix} ] [ \begin{matrix}{U}_{i} \\ {U}_{b}\end{matrix} ]$$

When applying boundaries conditions to the first node of each beam, one obtains U_{b}^{(α)}=0. Then, the local displacement of an internal node is:
Uᵢ^{(α)=}[Kᵢᵢ]⁻¹Fᵢ^{(α)}
The reaction on the boundary due to this local displacement will be:

$${F}_{b}^{( α )} = {\underbrace{[ {K}_{bi} ] [ {K}_{ii} ]}}^{- 1} {F}_{i}^{( α )}$$

When relaxing boundary conditions, the external force applied on an internal node i has already been taken into account, therefore Fᵢ^{(β)}=0 and:

$${U}_{i}^{( β )} = - \underbrace{{[ {K}_{ii} ]}^{- 1} [ {K}_{ib} ]} {U}_{b}^{( β )}$$

U_{b}=[K_{bb}—K_{bi}Kᵢᵢ⁻¹K_{ib}]⁻¹F_{b}^{(β)}
This leads to Fᵢ^{(α)=}Fᵢ. The opposite of the reaction on the boundary will be added to the external force to compute the final displacement of the boundary nodes:

$${U}_{b} = {\underbrace{[ {K}_{bb} - {K}_{bi} {K}_{ii}^{- 1} {K}_{ib} ]}}^{- 1} [ {F}_{b}^{-} {F}_{b}^{( α )} ]$$

As the value of F_{b}^{(α)} depends only on Fᵢ, the matrix [K_{bb}—K_{bi}Kᵢᵢ⁻¹K_{ib}]⁻¹ gives the value of the global flexibility (or compliance) on the boundaries. This result is obtained without inverting the whole matrix [K], which reduces greatly the computation. Indeed, even the computation of the Kᵢᵢ⁻¹, that could appear costly if the internal nodes are numerous, can be handled with a sub-substructure strategy, as illustrated in FIG. 7. The boundary nodes in the sub-substructure are the internal nodes of the substructure that are directly linked to the boundary nodes of the substructure by a non null K_{bi} or K_{ib}.

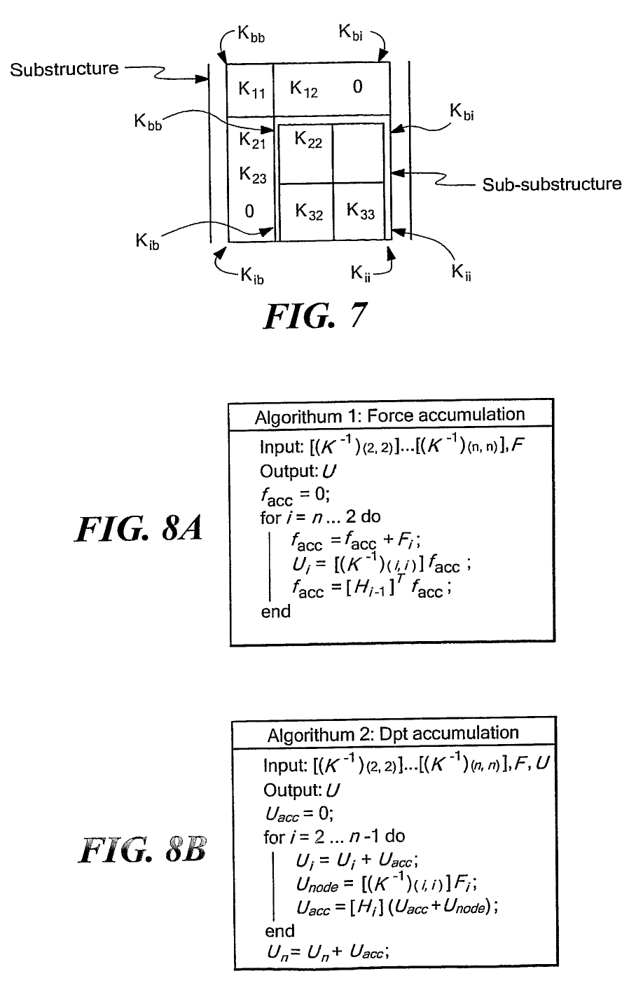

After the first computation, described above, one knows the global flexibility at the boundary of the first substructure. Then, a second recursive computation gives the global flexibility at the internal nodes, and their actual displacement:
Uᵢ=[Kᵢᵢ⁻¹+H₂K_{b}⁻¹H₁]⁻¹Fᵢ+H₂K_{b}⁻¹F_{b} (9)
The local flexibility at each node is required for collision response. This local flexibility also allows speed-up of the computation of the displacement U corresponding to different loads F if [K] remains the same. Two exemplary algorithms illustrating this process are shown in FIGS. 8A and 8B.

These algorithms use an accumulation strategy by going through the various levels of substructures. The force accumulation process takes into account the mechanical coupling from the finer substructures on the coarser substructures. The second process accumulates displacements from the coarser substructures to the finer substructures. For wire-like objects composed of serially-linked elements (such as catheters, guidewires), the substructure strategy permits solving the entire structure efficiently. Each joint between two elements will then be considered as a boundary.

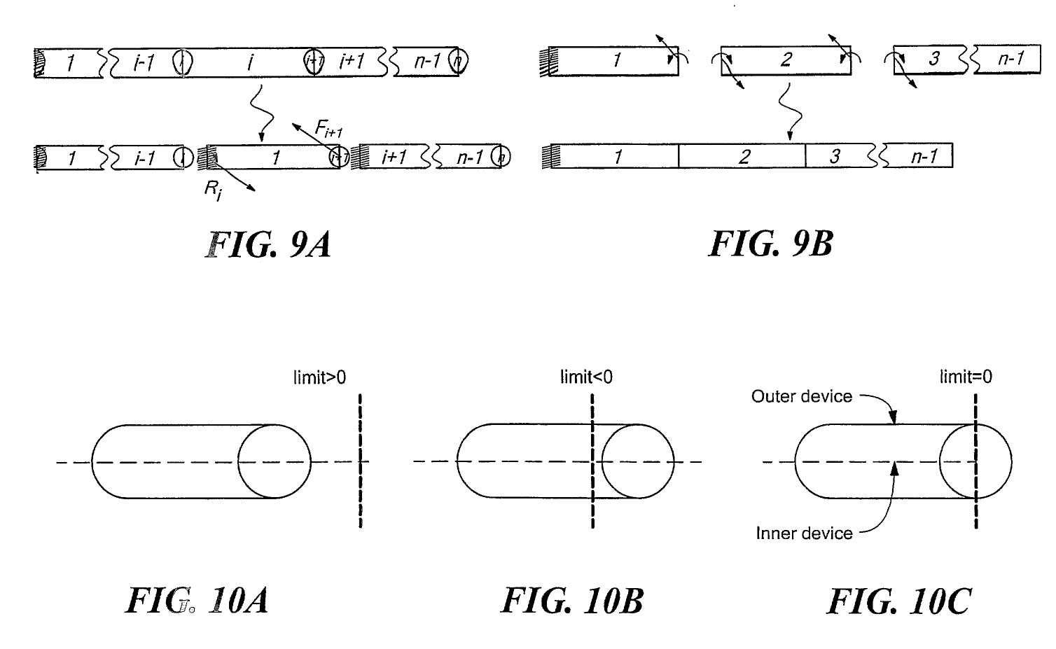

As shown in FIG. 9a, setting boundary conditions: the object is split in a series of substructures, and local displacements and forces are computed after constraining the first node of each substructure. As shown in FIG. 9b, relaxing boundary conditions: correction displacements are applied recursively, starting from node 1, at each first node of each substructure. The substructure method described above can however be applied to objects with a tree-like geometry, as described more fully below.

When a device such as a guidewire is inserted with a tight fit inside a device such as the catheter, the overall shape of both devices is modified due to a change in the bending stiffness and bending moment in the overlapped portion. Such a situation can also occur when a catheter or guidewire moves inside a vessel of small diameter. The region where the catheter and guidewire are coaxial offers a stiffer resistance to transverse loading. This meaningful visual cue can be simulated as a fiber reinforced composite material. The transversal stiffness of the overlapped region will be modeled with the well-established empirical expression, the Halpin-Tsai equations:

$${E}_{trans} = \frac{{E}_{cath} ( 1 + ξη f )}{1 - η f} , η = \frac{{E}_{guide} - {E}_{cath}}{{E}_{guide} + ξ {E}_{cath}}$$

where f is the ratio, in the overlapped section, of the guidewire volume over the volume of the guidewire-catheter combination; ξ is a function of the material properties and geometry of the instruments; and E_{guide} or E_{cath} describe the stiffness of the guidewire or catheter. Lookup tables describing typical values of ξ under different composition configurations are well known in the art. The stiffness for the overlapped section is updated in real-time and the both models reflect this change, accordingly. By using this approach, one can for instance represent the catheter-guidewire combination as a particular implementation of the initial catheter model. In addition, this allows one to avoid computing the collision between the two objects, as they are treated as a single composite model.

Visualization of the composite model is based on the definition of a curvilinear coordinate that determines the position of the inner device distal end relative to the outer device distal end as illustrated in FIGS. 10A-C, which show three possible settings associated with different values of the curvilinear coordinate.

Typically, if ‘limit’ is the value of the curvilinear coordinate, then a change in the value of ‘limit’ happens only when one of the devices is pushed or pulled. By doing so, it changes the existing relation between the two nested devices. Assuming the translation of a device is described by a signed value ‘translation’, an exemplary implementation to update the value of ‘limit’ is:

```
The guidewire is inside the catheter (limit < 0):
        A motion of the guidewire imposes an update of the limit value
        and checks for an potential effective translation:
        limit = limit + translation
        if limit > 0 then
            translation = limit
        else
            translation = 0
        end if
        Apply translation to the physical model extremity
        A catheter movement involves the following algorithm:
        limit = limit − translation
        if limit > 0 then
            translation = translation − limit
        end if
        Apply translation to the physical model extremity
The catheter moves along the guidewire (limit > 0): reciprocal algorithm.
```

Both nested devices can be rendered as generalized cylinders. This technique creates smooth surface representations of cylindrical shapes defined as a skeleton (in our case the set of beam elements) and a set of cross sections. Moreover, this technique can be optimized on state of the art graphics hardware.

By combining the inventive generic representation of a hollow lumen with the inventive real-time generic beam model one can also model and simulate the deformation of virtually any tubular structure, thus taking advantage of the characteristic and fast computation rates of the approach described below. By doing so, one can represent the deformation of devices such as stents, balloons, and also some local deformation of anatomical structures that have a tubular shape.

Therapeutic devices include, for instance, stents, angioplasty balloons, distal protection devices, or coils. For devices that have a similar geometry to a generalized cylinder, such as balloons and stents, a real-time finite element model of wire-like structures can be combined with generic modeling of tubular shapes to provide an efficient and flexible way to model a large range of devices.

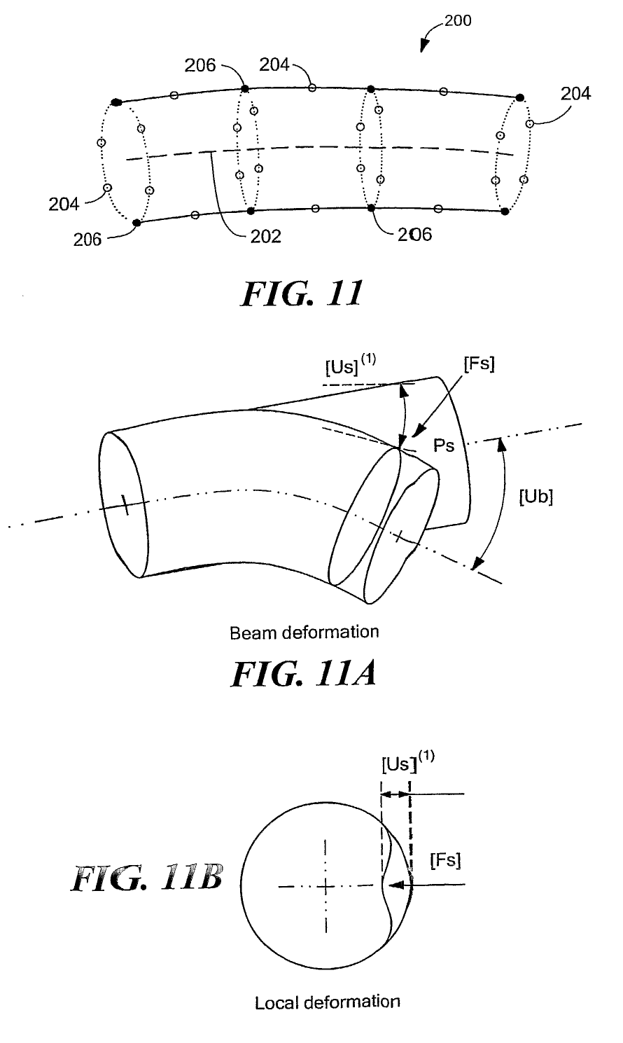

As illustrated in FIG. 11, the inventive scheme for a deformable device model 200, shown as a stent, is based on the following: a set of beam elements is used to define the skeleton 202 of the device, surface nodes 204, and collidable points 206. The beam elements are mapped to a surface representation adapted to the particular device being modeled. Since one difference between such devices and wire-like structures is their ability to handle radial deformations, one only need define the relationship between the skeleton and the surface representation.

The displacement [Us] of a surface point Ps is defined as a linear combination of two deformations, one due to the beam deformation [Us]^{(b)} and one local deformation [Us]^{(l)}:
[Us]=[Us]^{(b)}+[Us]^{(l)}
where [Us]^{(b)} is directly obtained from the beam model by interpolation of the displacement [Ub] of the n beam nodes, as describe by the following equation:
[Us]^{(b)}=Σᵢⁿ₌₀wᵢUbᵢ=[H][Ub]
The beam model gives the relation between forces [Fb] and displacements [Ub] of beam nodes:
[Ub]=[Kb]⁻¹[Fb]
Then, the forces [Fs] applied on the surface point are distributed to the different beam nodes using the transpose matrix of [H], [H]^{T}:
[Fb]=[H]^{T}[Fs]
Then a local deformation model gives also the relation between local motion displacement [Us]^{(l)} and forces applied to surface point.
[Us]^{(l)}=[K_{local}]⁻¹[Fs]
Using compliance (flexibility) formulation one can combine the two contributions:
[Us]=([K_{local}]⁻¹+[H][Kb]⁻¹[H]^{T})[Fs]

As shown in FIG. 11a, the deformation of a tubular structure is composed of a global deformation induced by the formation of the skeleton and a local deformation of the structure surface as shown in FIG. 11b.

Then a list of points sampled is distributed on the surface of the device, which will be used for collision detection purpose. These points are called “collidable points” 206 and will be used in the collision detection/collision response process similarly as discussed below.

During navigation or when therapeutic devices are deployed, a local deformation of a vessel, or in general any anatomical tubular structure, can occur. To model this deformation, in an exemplary embodiment, an approach similar to the one described above can be used. When contacts occur between a medical device and the surface of the anatomic structure, a contact force is computed, on the basis of the mechanical properties of the device and the tissue properties of the anatomy. The force is then applied to both objects in contact, and their deformation will occur according to the equations described above. The difference in behavior will be a function of the matrix [K_{local}] which takes into account the radial stiffness of the vessel wall.

When the structure is a blood vessel, a change in its geometry can have an impact on blood flow, for instance when a stent is placed at the location of a stenosis, the blood flow increases through the rest of the vascular network beyond that point. This change in resistance to blood flow is taken into account by a flow computation component, which is described below.

Collision detection involving one or more deformable structures is challenging, as is the problem of collision response. If collision response is not handled correctly it can be source of visual and haptic incoherencies. Further, when sliding occurs at the point of contact (when a catheter is advanced within an artery for instance), most conventional methods will not correctly constrain the deformable body. Penalty methods require the definition of a post-contact force that will attempt to constraint the model within the lumen. One issue with this approach comes from the difficulty of scaling the force in order to limit oscillations of the model at the point of contact, preventing the instrument from bouncing between the inside and the outside of the boundary defined by the tubular structure. This problem can be solved generally by directly constraining the position of the nodes in the FEM model instead of applying contact forces. A typical method includes adding Lagrange multipliers when solving the system of equations describing the catheter or guidewire undergoing a deformation. However such an approach cannot deal directly with non-holonomic constraints, as is the case when a flexible device slides along the surface of a tubular structure.

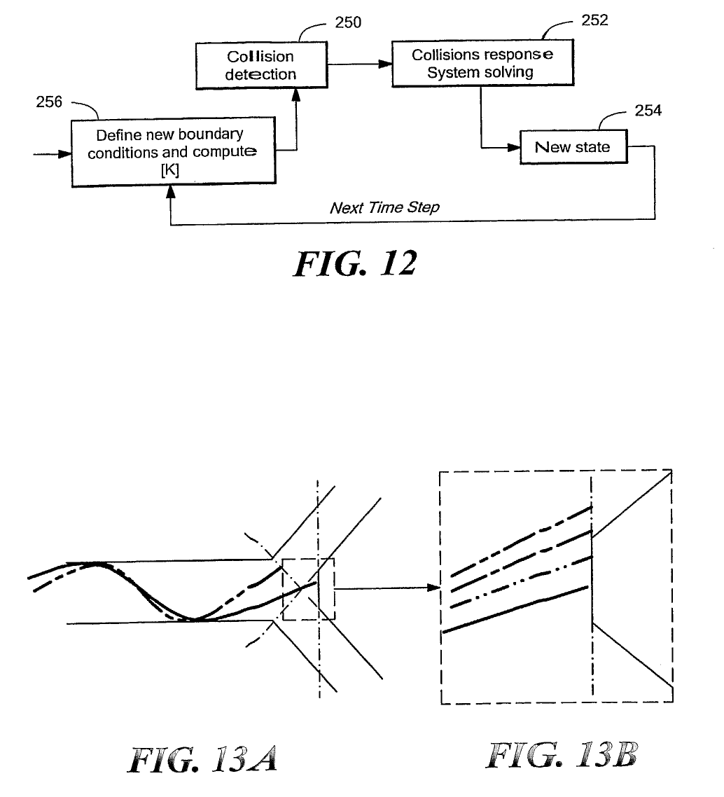

In an exemplary embodiment, as illustrated in FIG. 12, the collision response is implemented as a pipeline process, by taking the collision detection output 250, solving the system of equations of the finite element model while integrating contact information 252, and by returning the new state of the system 254, i.e. the new configuration of the flexible device. New boundary conditions are defined and [K] is recomputed 256 for input to collision detection 250.

For each collidable point on the surface of the flexible device, the collision detection algorithm returns a list of intersected triangle(s). Each triangle defines a linear constraint for the contact response process. Each linear constraint can be seen as an infinite plane that constrains the node of the deformable model to a half space. However, particular care has to be taken when the constraints for a given node are not complementary, i.e., when the set of triangles local to the intersected triangle do not form a convex set, which can result in sliding along artificial constraints (as illustrated in FIG. 13) or in general leads to an over-constrained system, where the device is no longer able to move freely inside the lumen. The combination of linear constraints based on infinite planes and non-convex sets of triangles lead to the creation of artificial boundaries that the device cannot cross, like the diagonal plane (FIG. 13a) or vertical plane (FIG. 13b).

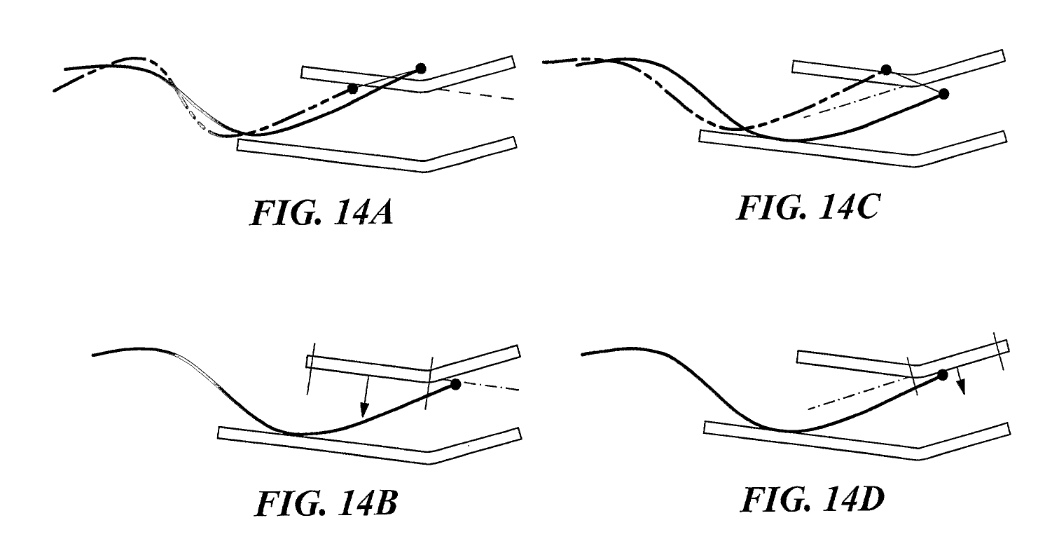

To address this issue, an inventive approach is based on bounded planes and convex sets of triangles. For each intersected triangle, a convex set of local triangles is found using the optimized anatomical representation described above. The node is then constrained within the sub-space defined by the convex set of triangles as shown in FIGS. 14a-d). After correction of the position of the node, if the projection of the node is not within the bounds of the triangle associated with the constraint, then a new local collision detection step is performed. The new triangle returned by the collision detection algorithm is used as a new constraint. Using constraints based on bounded planes (i.e. the projection of the constraint lies within the triangle) greatly improves the accuracy of the collision response. Finally, it should be noted that this inventive approach does not consider each node independently, but takes into account the whole structure of the device when correcting the position of a node, therefore maintaining a realistic, physics-based behaviour. Solving for the constraints can be done using a Gauss-Siedel algorithm, or quadratic programming approach, for instance.

In FIG. 14a, the detection collision returns the triangle intersected by the collidable point; in FIG. 14b the constraint associated to the triangle is applied to the deformable body, but after correction the collidable point does not project onto the initial triangle; in FIG. 14c another detection collision step is performed which returns a new triangle; in FIG. 14d the constraint associated with this new triangle is applied to the device and after correction one verifies that the collidable point projects within the bounds of this triangle.

An exemplary implementation illustrating steps of the process is described below:

Algorithm: Accumulative contact response

```
While convergence( ) Do
  |
  | For cp = 1... numberOfCollisablePoints Do:
  | |
  | | NewPos = ComputePosition (Position(cp), Accumulative_Force,
            K-1)
  | | test = 0
  | | While !test Do :
  | | | ContactInfo(cp) = Check_new_contact( NewPos )
  | | | CS = GetConvexSet( Contact_info(cp) )
  | | | [NewPos, F(point)] = ConstrainToConvexSet(CS, K-1,
                Pos)
  | | | test = 1
  | | | for each active triangle T in CS
  | | | P = ComputeProjection(NewPos)
  | | | if P not in T then test = 0
  | | | end
  | | End
  | | Position(cp) = NewPos;
  | | AccumulativeForce + = F(cp);
  | End
  |
  |
  | For cp = 1... numberOfCollisablePoints Do:
  |
  | | cp_index = numberOfCollisablePoints+1− cp
  | | NewPos = ComputePos( Position(cp_index), F(cp_index),
          K-1, AccumulativeDisplacement)
      | AccumulativeDisplacement = NewPos − Position(cp_index)
      | Position(cp_index) = NewPos ;
    End
End
Return Position(cp_index), F(cp_index)
```

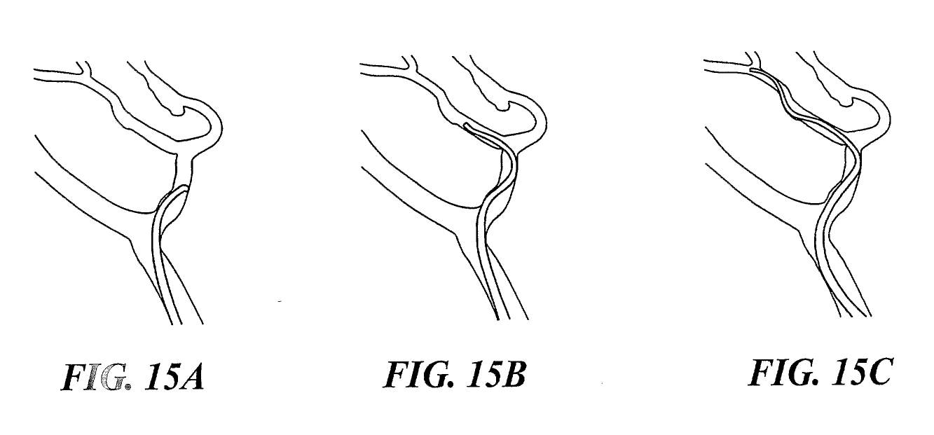

FIGS. 15a-c show catheter navigation inside the cerebrovascular network. Complex, non-linear deformations are correctly represented by the inventive incremental FEM model. Collision detection and collision response allow the catheter to stay within the lumen.

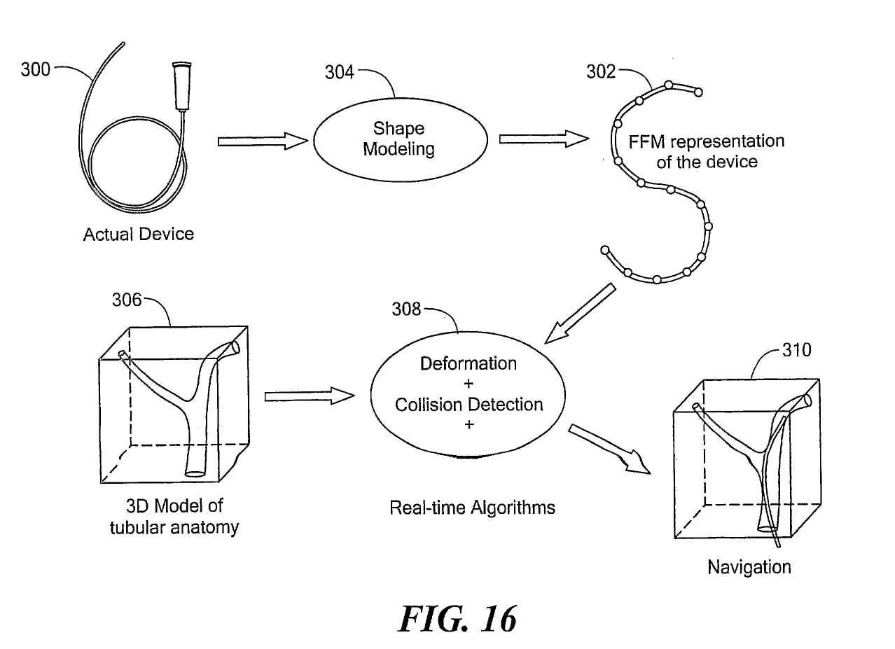

FIG. 16 shows a diagram illustrating an exemplary process that allows the computation, deformation and navigation of a virtual device inside a virtual representation of the anatomy. After identifying key characteristics of an actual device 300, a FEM model is built 302 via shape modeling 304. From a 3D model 306 of tubular anatomy, deformation of the model and collision detection 308 is computed in real-time according to the constraints defined by the geometry of the tubular structure: the model must remain inside the lumen, while moving according to the input from the user. From the computed deformation and collision detection, a navigation 310 for the user is generated.

Visual feedback is the perception channel that is most used in many medical specialties, and is considered by far the dominant channel in interventional radiology or endoscopy. The quality of visual rendering greatly influences user immersion and therefore the effectiveness of the simulation system. Whether the training system is used for navigation, diagnostic or therapeutic purpose, visual feedback remains essential.

Described below are two different types of rendering: visible light rendering and fluoroscopic rendering. The first is aimed at replicating the view of the anatomy as perceived by the human eye or a camera, the second uses simulated X-ray processing to replicate the imaging technique used in interventional radiology and some cases of surgical endoscopy. Both methods described below are optimized for fast rendering, thus allowing visualization of more detail in real-time, and therefore improving the quality of the visual feedback.

Rendering and shading of anatomical models under ordinary lighting conditions can be accomplished in hardware on the GPU using the standard OpenGL API, for example. Rendering usually involves computing a simplified bidirectional reflectance distributed function to determine the amount of light reflecting from the computer model surface into the viewer's orientation. Besides shading, models can also be texture mapped for more realism.

In another aspect of the invention, various rendering modes of the anatomy are implemented that can be used for different purpose. Using a combination of smooth shading and transparency can help visualize a medical device as it navigates through the anatomy. When simulating endoscopic procedures, texture mapping combined with bump mapping techniques can greatly enhance the visual realism and reproduce some of the texture variations associated with changes in soft tissue properties.

A real-time rendering engine of the present invention is a novel interactive volume rendering approach for the simulation of fluoroscopic X-ray images directly from patient specific volume datasets such as Computed Tomography (CT) or Computed Tomography Angiography (CTA). Previous methods have used segmented surface models but these are tedious to generate and lack the complexity of human anatomy. Simpler algorithms have used real X-ray images as a backdrop to the virtual scene but this severely restricts interactivity.

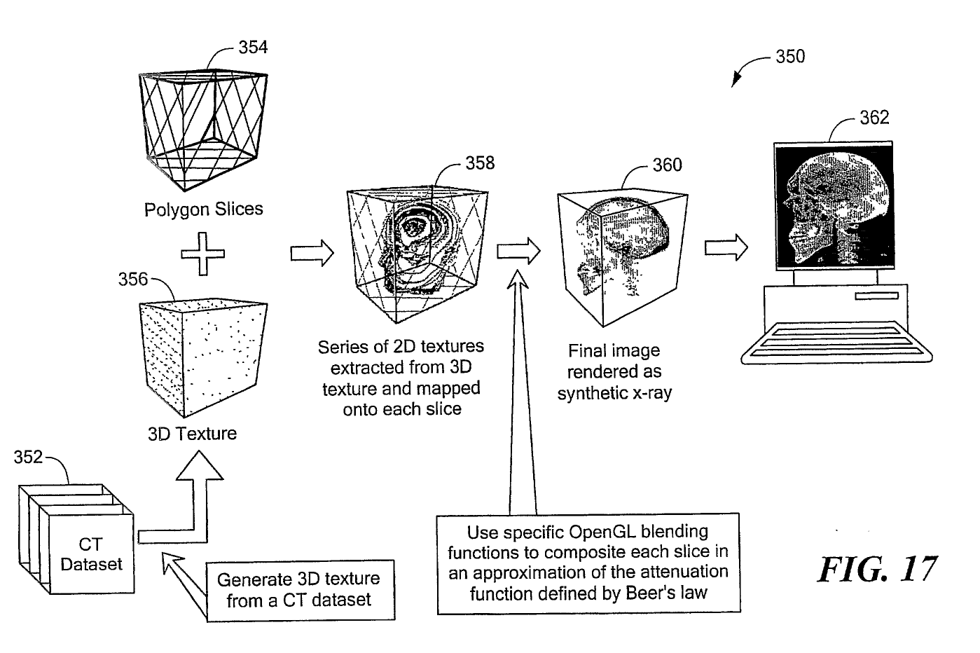

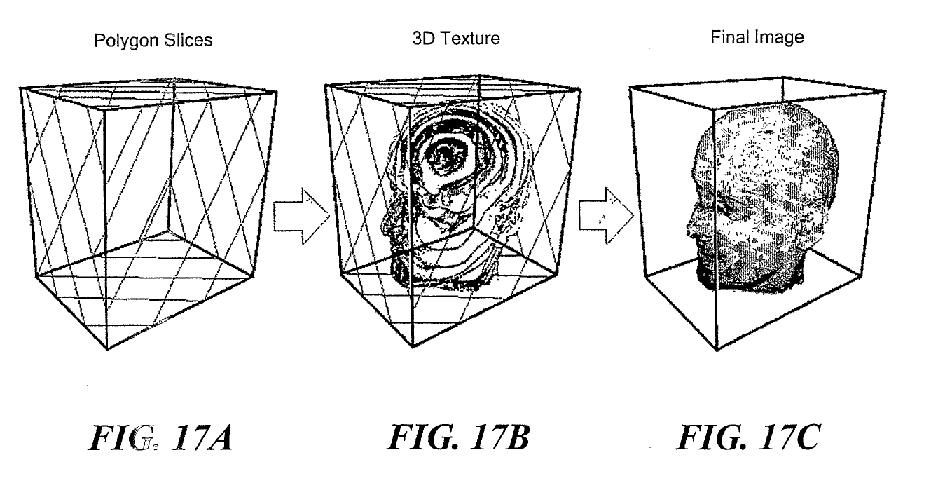

FIG. 17 shows an exemplary process 350 of volume rendering for simulating images directly from a CT dataset 352. Polygon slices 354 and 3D texture 356 are combined to generate a series 358 of 2D textures extracted from 3D texture 356 and mapped onto each slice from the CT scan. A final image 360 is rendered as a synthetic X-ray on a workstation 362 for example.

Using the standard OpenGL rendering library and standard graphics hardware, the inventive technique can display actual patient volumes directly using three-dimensional texture maps, as well as integrate traditional geometric primitives for catheter, guidewire and other devices. A ray casting rendering method uses a specific accumulation blending algorithm to implement X-ray attenuation process using Beer's law:
I=I₀e^{-μd}
where I the output intensity is a function of I₀ the input intensity, μ the coefficient of linear attenuation of the material, and d the traversed depth of material. Differences in linear attenuation coefficients among tissues are responsible for X-ray image contrast.

One step of the algorithm recovers the μ attenuation coefficients from the original Hounsfield units (H) of a Computed Tomography image by adjusting it to the attenuation of water and air:
μ=(H*(μ_{water}−μₐᵢᵣ))/1000+μ_{water}
The resulting μ values are stored into an OpenGL volumetric texture map. The volume rendering algorithm creates a set of parallel evenly spaced (separated by thickness d) polygons or slices within the attenuation volume which can be rendered and blended in order to simulate X-ray beam attenuation at a given user's viewpoint as shown in the images shown in FIGS. 17a-c.

This can be accomplished, for example, by using the function glTexEnvf(GL_TEXTURE_ENV, GL_TEXTURE_ENV_MODE, GL_MODULATE) on the μ values stored as texture alpha values (GL_ALPHA) multiplied by the thickness value. As a result, the alpha color channels of the textured slices contain the cumulative product pd. The source of the X-ray beam is simulated by a white (RGB={1.0, 1.0, 1.0}) plane drawn on the background of the scene with the blending function glBlendFunc(GL_ONE, GL_ZERO). This sets the values of the destination buffer with the values of the plane: I₀ Then, the final step consists in attenuating the beams emitted by the source with the proper algorithm. This is done by using the blending function glBlendFunc(GL_ZERO,GL_ONE_MINUS_SRC_ALPHA). For each color channel C, the blending process in OpenGL is defined by:
C_{d}(n+1)=Cₛ. S_{c}+C_{d}(n).D_{c}
where C_{d}(n+1) and C_{d}(n) are the value of the channel in the destination buffer at steps (n+1) and (n), Cₛ is the value of the channel in the source buffer, and S_{c} and D_{c} are respectively the blending factors of the source and destination. The function glBlendFunc(GL_ZERO,GL_ONE_MINUS_SRC_ALPHA) defines S_{c}=0, and D_{c}=(1−αs), where αs is the value of the alpha channel of the source. Since the slices are drawn from back to front, each slice number n defines the values of the source buffer at step n. According to what has been stated before, one can deduce that the value as equals to μd. Then, the previous equation becomes:
C_{d}(n+1)=Cₛ.0+C_{d}(n).(1−αs)=C_{d}(n).(1−μd)
Since C_{d}(0)=I₀, then C_{d}(1)=C_{d}(0). (1−μ0 d)=I₀. (1−μ0 d)=I₁, and so on . . . In represents the intensity of the original X-ray beam I₀ attenuated by traversing the n slices, which define the attenuation properties of the physical materials, along the path of the beam.

With sufficient texture memory, this rendering technique can be optimized on the graphics processing unit (GPU) to produce rendering speeds of 50 frames per second with a 512³ volume. To accelerate the rendering even further, one can limit the computational requirements imposed to the graphic card when the data set is observed from a temporary static point of view. This is done by rendering the volume into a two-dimensional texture (or P-buffer), and then by compositing this 2D texture with the other geometric primitives to be rendered. The final image cannot be differentiated from one that would be computed at each frame using a 3D texture, but can be rendered at a higher frame rate (60 images per second or more), while requiring very limited resources from the GPU. This permits in turn to use the available resources for other rendering purpose, such as described below.

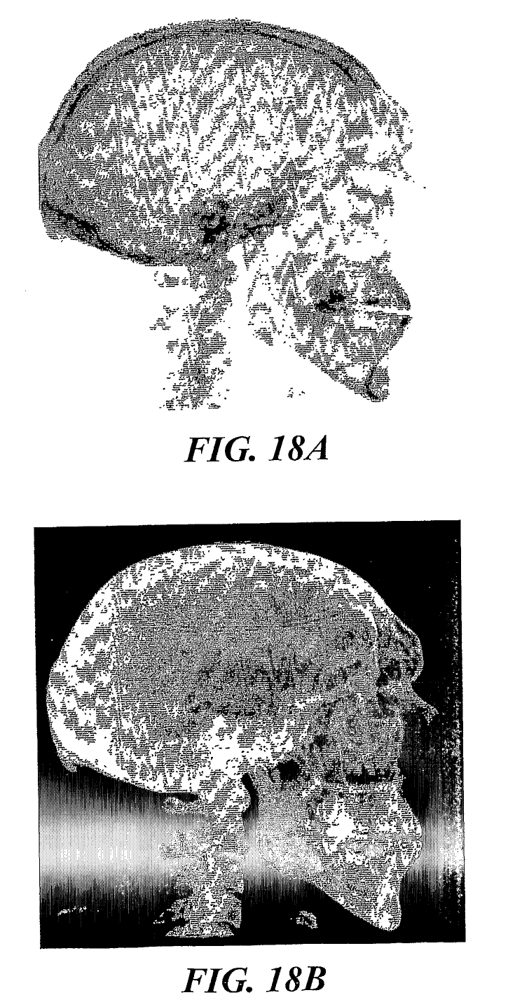

Collimation, used in interventional radiology to reduce the area exposed under X-rays, is simulated using a stencil buffer, a typical feature of common 3D graphics cards. Stencil rendering takes place before rendering on the screen. When activated, the stencil buffer acts as a mask, only allowing certain pixels to be rendered on the screen. Using this technique, one can define interactively a circular mask, and other more complex shapes as shown in FIGS. 18a-b. In addition, when using the stencil buffer to simulate the effect of collimation, since fewer pixels have to be rendered on the screen, it also accelerates the rendering of the image.

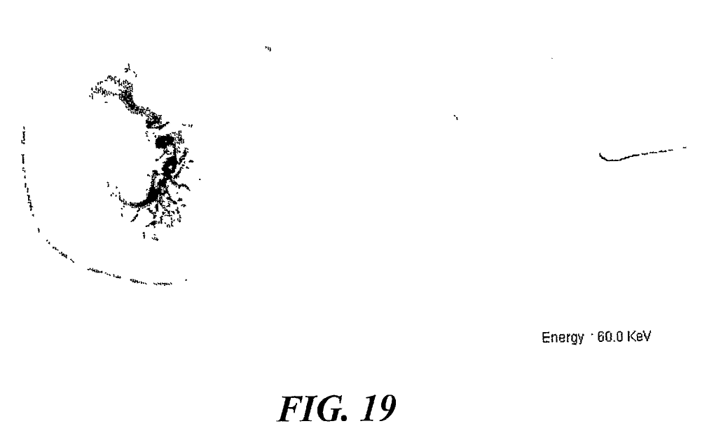

In an exemplary embodiment, road maps are created by using Digital Subtraction Angiography (DSA), e.g., by subtracting a saved fluoroscopic image from a current one. When contrast agent is injected through the vascular network and the corresponding fluoroscopic image is saved and then digitally subtracted from any new image, only the vascular system remains visible, as well as the devices that are advanced through the vascular system. This is what defines a road map. Such road maps can be simulated by saving the current simulated fluoroscopic view as 2D texture and subtracting it from any future fluoroscopic view. This subtraction is implemented using a specific blending operation. The end result is the same as a DSA, and can be implemented in real-time on any current 3D graphics card. An example of such a DSA is illustrated in FIG. 19.

The inventive X-ray rendering generates real-time synthetic X-ray images directly from CT/CTA volume datasets or other volumetric image modality. The generated images are nearly indistinguishable from real fluoroscopic images. The rendering algorithm is based on volume rendering and multi-texturing techniques. The algorithm runs on affordable commonly available graphics hardware, it is scalable and uses multi-resolution refinement based on the user's selections and available rendering resources. Most typical features of real fluoroscopes used in interventional radiology can be simulated, like for instance collimation, or road mapping.

In the context of interventional radiology, although a physician can only see the anatomy through a series of X-ray images (which do not always permit distinctions between different anatomical structures and are only two-dimensional), training simulators have the flexibility of augmenting the visual feedback by, for instance, displaying anatomical models using visible light. By compositing synthetic X-ray rendering with visible light rendering techniques, an augmented view can be created which is not achievable during an actual procedure. This “augmented reality” display has obvious educational advantages as it teaches the spatial and functional anatomical relationships.

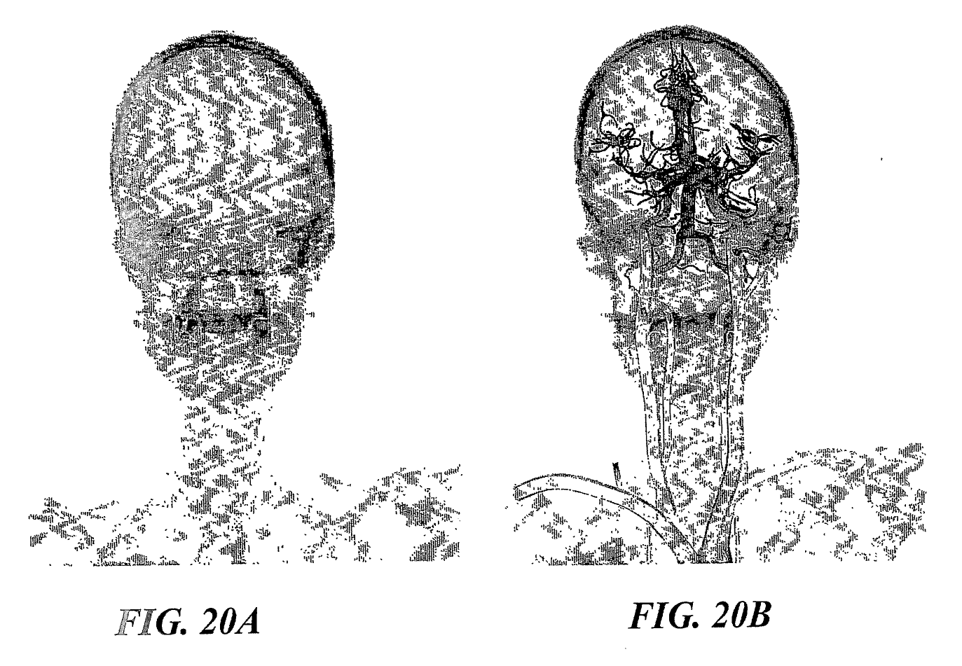

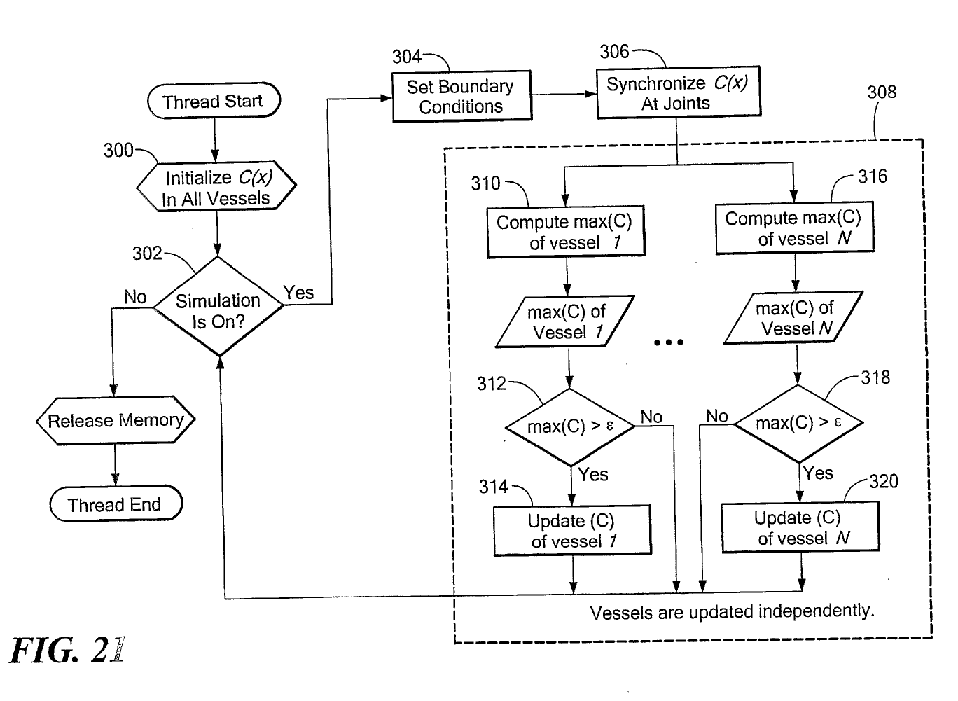

FIGS. 20a,b show two examples of this concept where a synthetic X-ray image is combined with a three-dimensional model of the arterial vascular network, displayed using visible light rendering. FIG. 20a shows that the arterial side of the vascular network is visualized and can be used as a three-dimensional roadmap, for better understanding of relationships between the X-ray view and actual anatomy. FIG. 20b shows a display of the vessels illustrates the blood pressure in different zones of the anatomy.

Simulating respiratory and cardiac motion is desirable since they both influence the visual feedback and the navigation through the anatomy. It is represented as a volumetric deformation, which is controlled by specifying a cyclic, time-dependent displacement of a set of control points on a three-dimensional grid. From the deformation of the grid, the displacement of any point inside the bounding box defined by the grid can be computed. Examples of volumetric deformation schemes include, but are not limited to, Free Form Deformation or three-dimensional splines. The three-dimensional grid does not need to be regular; therefore more local deformations can be specified at certain anatomical locations. The deformation of the tree-dimensional grid can very easily be used to control the deformation of the volumetric texture used for rendering the fluoroscopic images, since each slice on which is mapped a section of the texture can be deformed, thus inducing a deformation of the texture. The deformation of any tubular anatomical model can also be represented using a similar principle, by computing the deformation of the medial axis representation, which will then induce an update of the surface and volume representations. These transformations can be computed in real-time. In addition, since the topology of the medial axis is not changed, there is no impact on the computation of the contrast agent propagation, or collision detection, since they only rely on curvilinear coordinates. Finally, the motion of any device navigating within the anatomy will respond to the deformation thanks to the collision detection and collision response algorithms.

In another aspect of the invention, real-time simulation of three-dimensional angiography is provided. To compute blow flow throughout a complex vascular network in real-time one can rely on a one-dimensional Finite Element representation. The vasculature is modeled as a one-dimensional graph composed of finite elements defining the length of a vessel between two bifurcations. This graph is easily derived from the medial axis representation described above. Each element is defined with a radius equivalent to the average radius of the vessel and a length identical to the length of the three-dimensional vessel. In this modeling scheme, blood flow is treated as an incompressible viscous fluid flowing through a cylindrical pipe. The resulting equation, called Poiseuille's law, relates the flow [Q] in the vessel to the pressure gradient ΔP, viscosity of the fluid η, radius r, and length L of the vessel:

$$Q = \frac{Δ P}{R} with R = \frac{8 η L}{π {r}^{4}}$$

This is analogous to a resistive network in which the resistance would be a function of the length and radius of the vessel. This presented model leads a set of linear equations and constraints in the form:
[Q]=[P]/[R]
where [P] is the pressure at each node, [R] is the equivalent resistance of the vascular system, and [Q] is the flow through each node of the graph. Solving for [P] with a known, time-varying value for the flow at the parent node and a set of boundary conditions defining known pressure values at terminating nodes, will provide a value for the pressure at each node. Then, using Poiseuille's equation, the flow through each branch is computed in real-time. Since [R] does not depend on the geometry of the vascular network but only its topology and radius information, [R] can be pre-inverted thus highly improving computation times. If the radius is altered due to a simulated angioplasty of stenting, the inverse of [R] is then recomputed using a Sherman-Morrison formula for instance, which is more efficient than a full inversion.

Contrast agents, also known as contrast media or dye, are often used during medical imaging examinations to highlight specific parts of the body and make them easier to see under X-ray, CT, and MRI. Upon injection, the contrast agent mixes in the blood stream and circulates throughout the vasculature. The X-ray beam is highly attenuated by the iodinated fluid, resulting in high contrast between the vessel lumen and the surrounding unopacified tissue.

In a further aspect of the invention, a real-time algorithm computes contrast agent propagation using a one-dimensional advection-diffusion model to determine the concentration distribution of contrast agent in the vasculature upon injection. Features of the algorithm include:
1. Unified framework to handle various types of contrast agents: depending on the type of contrast agent, the degree of its diffusion into the blood stream varies. By adjusting the value of diffusion coefficient according to contrast agent type, a particular type of contrast agent can be simulated accurately.
2. Extensible numerical solvers: The contrast agent concentration distribution C(x,t) in the vascular system is parameterized by the time t and a curvilinear coordinate x associated with the medial axis defined above:

$$\frac{\partial C ( x , t )}{\partial t} + u ( x , t ) \frac{\partial C ( x , t )}{\partial x} = D \frac{{\partial }^{2} C ( x , t )}{\partial {x}^{2}} + r ( t )$$

where r(t) is the injection rate of contrast agent, u(x,t) is the averaged laminar flow velocity along the axial direction of each vessel, and D is the diffusion coefficient. Any stable explicit or implicit numerical partial differential equation (PDE) solver can be used to solve the above continuous advection-diffusion equation. Various explicit and implicit schemes can be implemented, including forward-in-time and central-in-space (FTCS), backward-in-time and central-in-space (BTCS), Lax Wendroff, Crank-Nicolson, and DuFort-Frankel finite difference algorithms in our system. As an illustration, FTCS method approximates the continuous equation with linear accuracy in time and quadratic accuracy in space.

$$\frac{{C}_{m}^{n + 1} - {C}_{m}^{n}}{k} + {u}_{m}^{n} \frac{{C}_{m + 1}^{n} - {C}_{m - 1}^{n}}{2 h} = D \frac{{C}_{m + 1}^{n} - 2 {C}_{m}^{n} + {C}_{m - 1}^{n}}{{h}^{2}} + {r}_{m}^{n}$$

where k and h are the time and space discretization intervals, and n and m are temporal and spatial discrete points, respectively. For one-dimensional flow, the current velocity at location xₘ is defined as uₘⁿ≈Q(n)/A(m) where Q(n) is the flow value at time stamp n and A(m) is the area of the vessel cross-section at location xₘ. In this invention, the explicit DuFort-Frankel scheme is also used to solve the advection-diffusion equation with better numerical stability. Explicit Lax-Wendroff method is a second order scheme with quadratic accurate both in time and in space. An implicit numerical scheme, BTCS,

$$\frac{{C}_{m}^{n + 1} - {C}_{m}^{n}}{k} + {u}_{m}^{n} \frac{{C}_{m + 1}^{n + 1} - {C}_{m - 1}^{n + 1}}{2 h} = D \frac{{C}_{m + 1}^{n + 1} - 2 {C}_{m}^{n + 1} + {C}_{m - 1}^{n + 1}}{{h}^{2}} + {r}_{m}^{n}$$

as well as implicit Crank-Nicolson scheme, is implemented as well. The implicit method provides unconditional stability with a tradeoff of higher computation cost over its explicit counterparts. The higher computation cost is bounded by deploying Thomas algorithm. Above implicit numerical schemes for a vessel can be rewritten as

$${a}_{m}^{n + 1} {C}_{m - 1}^{n + 1} + {b}_{m}^{n + 1} {C}_{m}^{n + 1} + {c}_{m}^{n + 1} {C}_{m + 1}^{n + 1} = d ( {C}_{m - 1}^{n} , {C}_{m}^{n} , {C}_{m + 1}^{n} ) + {r}_{m}^{n}$$

where aₘⁿ⁺¹, bₘⁿ⁺¹, cₘⁿ⁺¹, rₘⁿ are known coefficients. The resulting linear system equations is a banded matrix with half bandwidth 1. Our implicit numerical schemes use Thomas algorithm to directly solve the linear system with linear cost.
3. Independent concentration distribution update: updating the contrast agent concentration distribution of the entire vascular network in real-time is a very challenging task due to the very large number of vessels in the vascular network. The parameters of the advection-diffusion equation are both timely and spatially dependent. In order to efficiently solve this problem, a strategy was devised where each vessel can be updated independently. When a vessel is connected to other vessels, its end sampling points are shared with those adjacent vessels. The concentration value at an end sampling point, associated to the branch point, is used as a boundary condition for the connected vessels. After all the vessels are updated, a synchronization process unifies the values of the boundary conditions at the branch points. The decoupled system is much faster to update since no global system of equation needs to be solved, and the computation scheme makes it very flexible to incorporate various numerical schemes for solving local sets of equations. The independent vessel update ensures linear computation cost and scalability, thus enabling the invention to benefit from the advantages of multiprocessor computers.

To further improve the simulation performance, another optimization strategy is designed to bypass the distribution update on a vessel when the concentration of contrast agent is inferior to the rendering threshold, because the color depth of the X-ray process will not be able to differentiate that value from zero. This is achieved by checking whether the maximum norm of the contrast agent concentration value at each sampling points is larger than a predefined threshold ε:

$${C}_{max}^{n} ( i ) ≡ {max}_{m} ( {C}_{m}^{n} ( i ) ) or {\vert {C}_{m}^{n} ( i ) \vert}_{∞}$$

if Cₘₐₓⁿ(i)<ε, then there is no need to update the concentration distribution of vessel i at discrete time stamp n. The technique guarantees only to compute contrast agent propagation in a vessel when necessary. Pseudo code to implement the function simulating the propagation in the vascular network is set forth below and shown in FIG. 21.

Pseudo code for contrast agent propagation

```
//----------------------------------------------------------
// Simulate the propagation of contrast agent in blood vessel
// Data structure CA contains the information of current injection,
// including CA type, injected volume, and injection flow
//----------------------------------------------------------
Initialize_All_Vessels(CA);
while (Simulation_Is_On),
    //Set CA injection boundary condition at the roots and leaves
    //of the vascular tree.
    Set_Boundary_Conditions( );
    //Synchronize the concentration value of branch point nodes.
    //These joint nodes are shared by connected vessels.
    Synchronize_CA_At_Bifurcation( );
    //Calculate the maximum CA concentration within each vessel
    for i =1:num_of_branches,
        max_CA[i] = Max_CA_In_Vessel(i);
        //Apply any stable explicit or implicit
        “NUMERICAL_SCHEME”
        //on individual vessel to advance advection-diffusion
        //equation. Use the threshold “EPSILON” to control
        //whether a vessel's CA distribution needs to be updated.
        if (max_CA[i] > EPSILON),
            Update_Vessel(i, NUMERICAL_SCHEME);
        end;
    end;
end;
```

FIG. 21 shows an exemplary sequence of steps implementing a computation process simulating the propagation of contrast agent in a vascular model. After initialization in step 300, a determination that the simulation is on in step 302, the boundary conditions are set in step 304 and contrast agent concentration is synchronized in step 306, simulation process enters an infinite loop 308 that updates the boundary conditions and synchronizes the concentration value at the branch points. Then the concentration distribution of each vessel is computed independently as shown in the dotted region. More particularly, in step 310 the concentration of vessel 1 is computed and compared against a predetermined threshold, which is dependent to the X-ray rendering depth, in step 312. If the concentration is greater than the threshold, then the concentration distribution for vessel 1 is updated in step 314. A similar numerical PDE solver runs independently to update every other vessel's contrast agent concentration, shown as in steps 316-320. To be more efficient, the algorithm bypasses the numerical advection-diffusion update when max(C(x))<ε within a vessel.

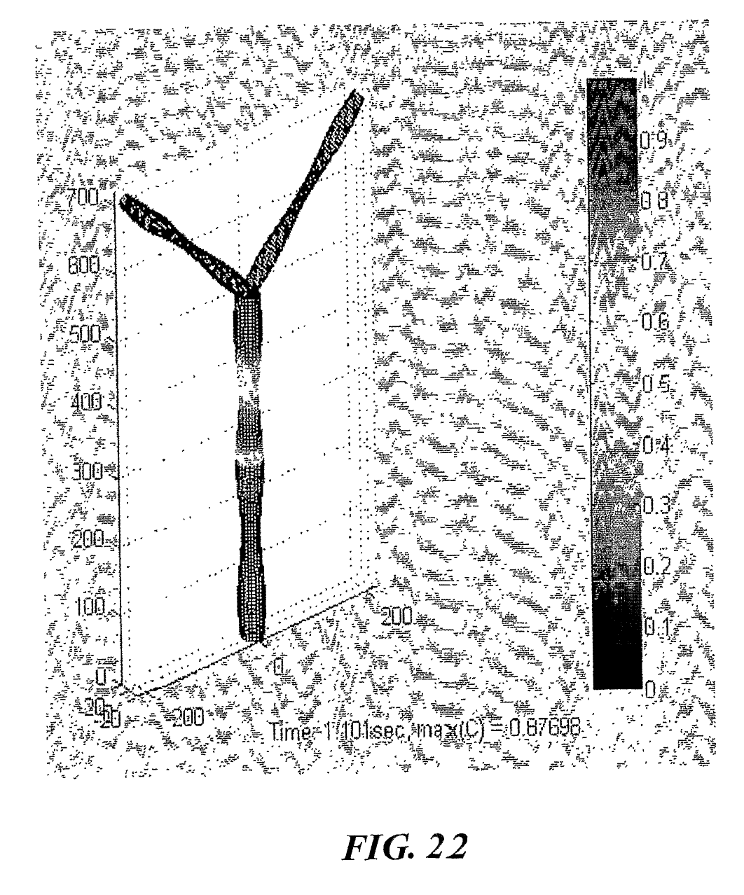

FIG. 22 shows the propagation of contrast agent in a vascular model 350 with bifurcation. The color bar 352 at the right indicates the value of the contrast agent concentration from 0 to 1. The simulation of such propagation is determined by FTCS solution of one-dimensional advection-diffusion equation.

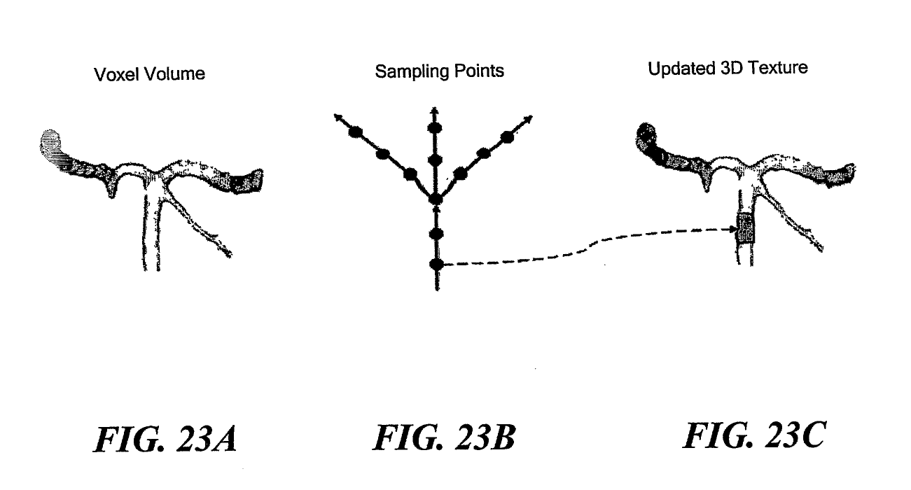

In another aspect of the invention, a real-time algorithm computes contrast agent propagation that updates a volumetric representation of the vascular network. This approach improves greatly the realism of the visual feedback compared to methods based on polygon-based representations. The solution of the advection-diffusion equation gives the concentration value of contrast agent at every sampling point along the medial axis of the vascular network, as shown in FIGS. 23a-c, where each sampling point along the medial axis is mapped to a set of voxels (here the term voxel is used in its most generic meaning i.e., a voxel is a small three-dimensional cell) defining the volume of the tubular structure. The value of each sampling point is then transferred to the intensity value of such set of voxels defining the volume of the lumen. To further enhance the visual realism, the intensity of a given voxel is interpolated between the concentration values of the two adjacent sampling points that are closest to that voxel. Currently, the simulator uses linear intensity value interpolation as following:
I_{m,j}=I(\tilde{α}Cₘⁿ+(1=\tilde{α})Cₘ₊₁ⁿ)
where I_{m,j} is the intensity value of the j^{th} voxel mapped to sampling point xₘ which contrast agent concentration value is Cₘⁿ. In this formula, xₘ and xₘ₊₁, are the two closest sampling points to voxel (m,j). The weight \tilde{α} in the above formula consists of two parts: a definitive ratio α and a random incremental rand. α represents the ratio of the Euclidean distances from the voxel to the sampling point:

$$\tilde{α} = α + rand = \frac{d ( {v}_{m , j} , {x}_{m} )}{d ( {v}_{m , j} , {x}_{m} ) + d ( {v}_{m , j} , {x}_{m + 1} )} + rand$$

where d(v_{m,j}, xₘ) is the Euclidean distance between voxel v_{m,j} and the sampling point xₘ on the vasculature graph. rand is a random value ranging from −0.1 to 0.1. Directly applying α creates a uniform rendering pattern in the surface symmetric around the local tangent of a vessel's medial axis. The additional randomness effectively improves rendering realism in a very efficient way. Performing voxel intensity interpolation provides a smoother, more natural visual feedback of contrast agent propagation. While the choice of linear interpolation is governed by real-time constraints, other interpolation schemes, and/or using more neighbor sampling points, can also be implemented.

The update of the volumetric representation of the propagation is rendered seamlessly by combining the three-dimensional fluoroscopic texture with the volume of data corresponding to the contrast agent. One embodiment uses a three-dimensional texture which coordinates are mapped to sample points of the medial axis. Another embodiment maps each sampling point to a set of particles (three-dimensional spheres or disks) that also represent as discretization of the volume of the vascular network, as described above. The combination of particle rendering and volumetric texture rendering enhances the level of realism of the visual feedback while maintaining real-time performance.

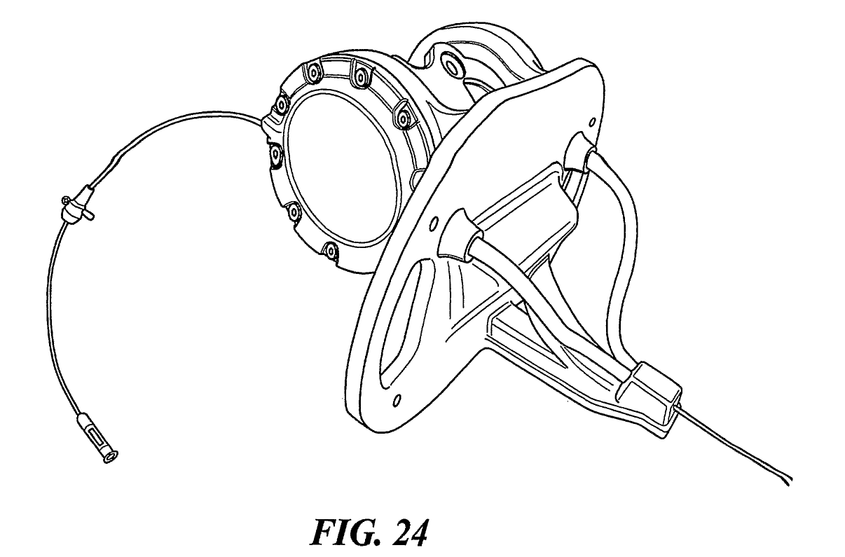

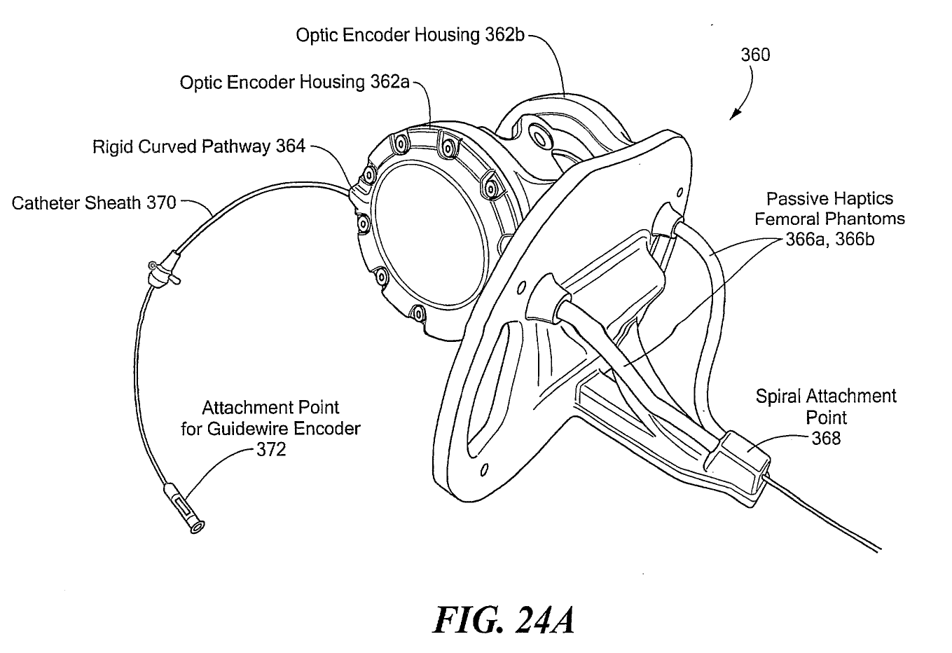

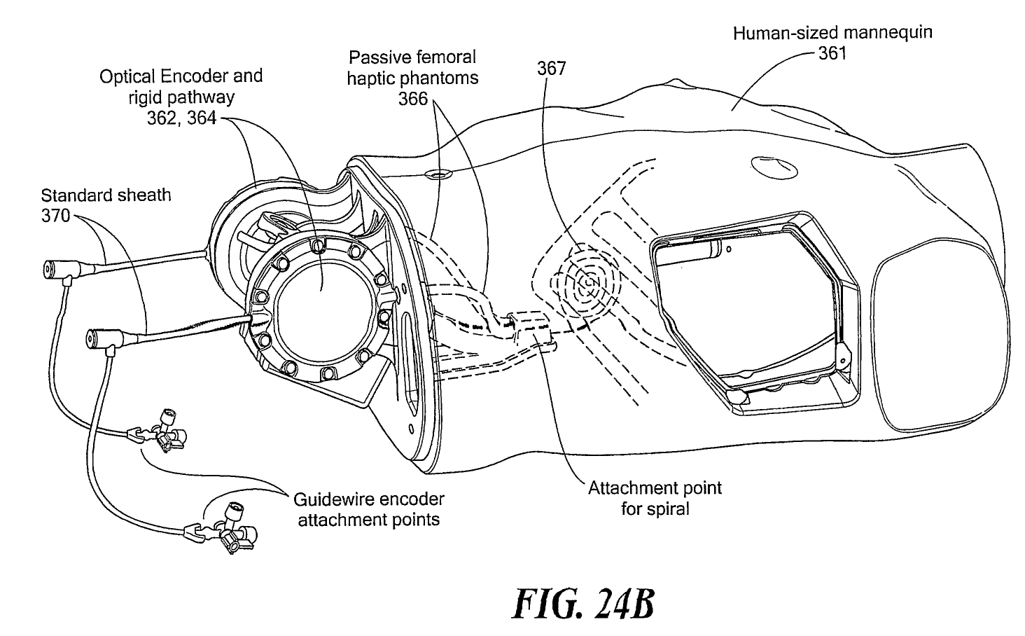

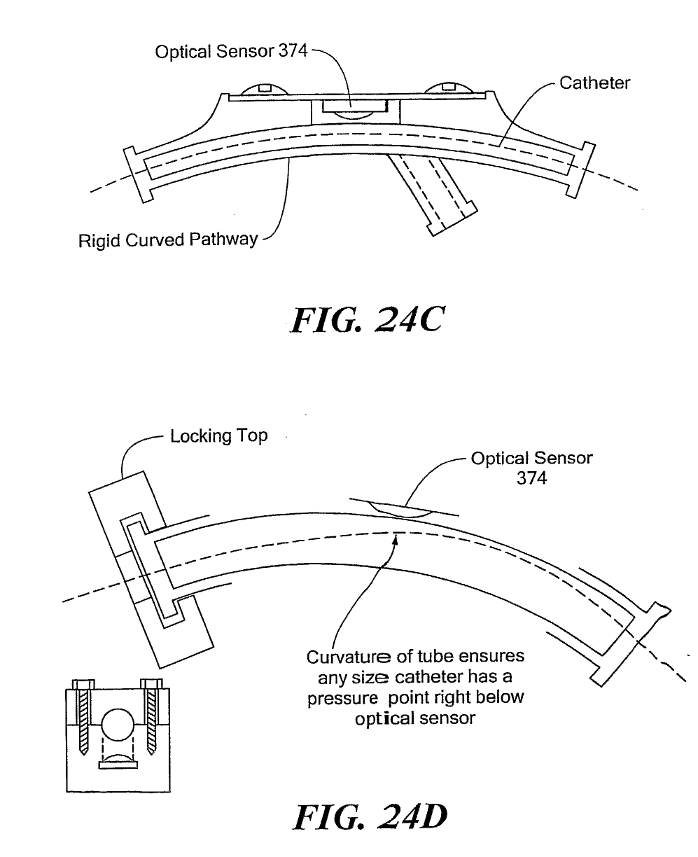

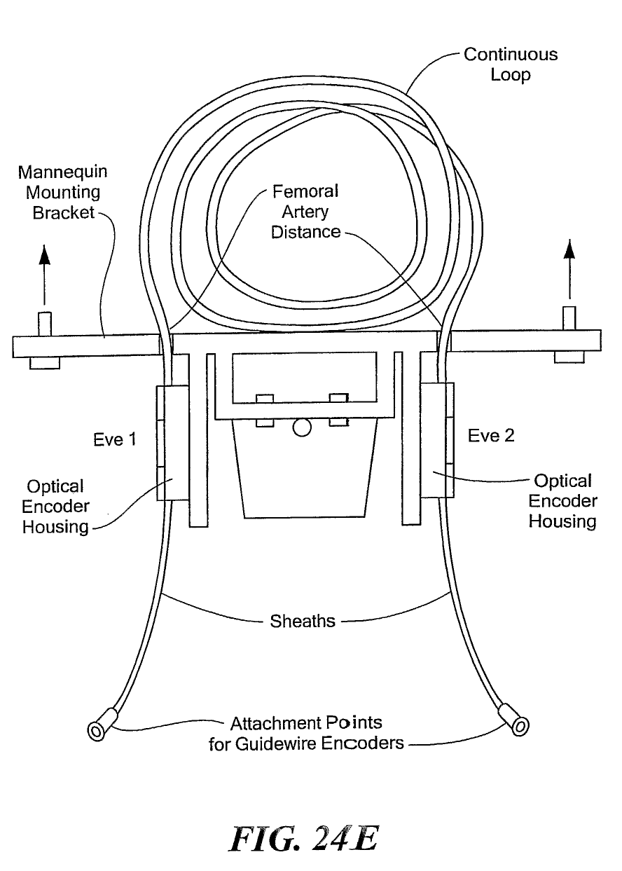

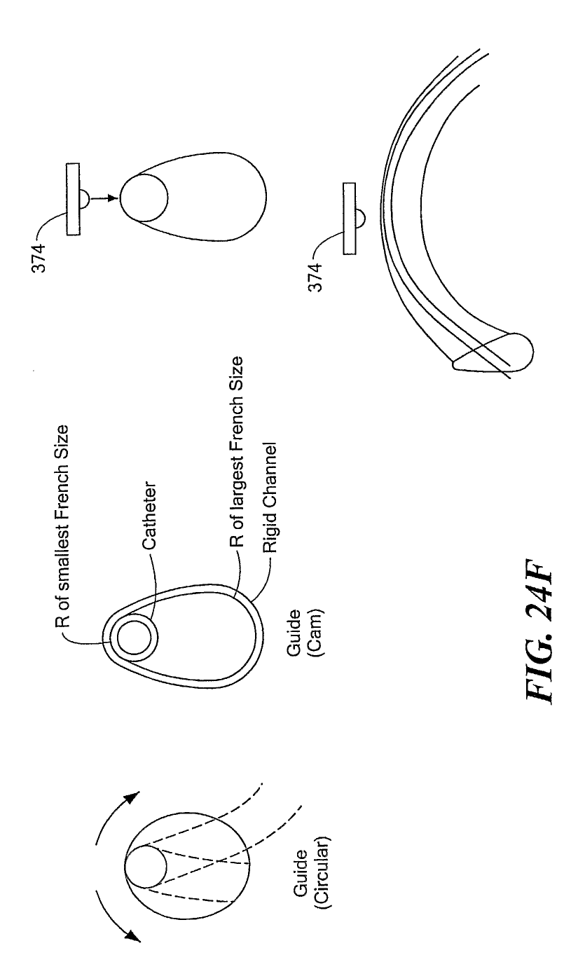

In a further aspect of the invention, a tracking interface 360 for endoluminal instruments is provided as shown in FIGS. 24a-f. The system 360 can be coupled to a human-sized torso model 361 (FIG. 24b) to increase training immersion. Conventional tracking devices for flexible instruments are frequently expensive, complicated, and over-engineered for the task of tracking nested endoluminal devices. The inventive tracking device combines cost-effective optical sensing systems with robust engineering designs to provide the necessary haptic feedback to the user without sacrificing accuracy or reliability.

The tracking system 360 includes dual optical encoder housings 36a,b, (one could be used), a rigid curved pathway 364, and passive haptic femoral phantoms 366a,b merging to a spiral attachment point 368. In an exemplary embodiment, the system further includes a catheter sheath 370 coupled to the pathway 364 and an attachment point for a guidewire encoder 372.

The tracking system 360 utilizes a number of optical sensors arranged along the path of a pair of nested endoluminal instruments to provide position data and haptic feedback to the system. This system returns the position of both the guidewire and guide catheter for use in a neuroendovascular simulator for diagnostics and stent placement simulation. In other embodiments, the tracking system has the ability to track the position of flexible endoscopes. The inventive embodiments will describe the implementation of a catheter/guidewire tracking application.

The tracking device 360 relies on a set of non-contact miniature optical encoding devices 374 which accurately track the translation and rotation of two nested original endovascular instruments resulting in a more compact and robust method of instrument tracking, without requiring modification to the instruments. There are two tracking units per side of the system: one to track the catheter, one to track the guidewire.

The catheter unit forms the base of the device, while the guidewire unit is tethered to the end of the catheter where a stopcock or manifold would typically be attached. This combination allows the tracking system 360 to maintain a minimal footprint and thus can be wholly contained within a human form (FIG. 24b) for potential incorporation into mannequin-based simulators. Therefore, the compact size of this arrangement naturally allows the working environment found in the procedure room to be recreated. This aspect is also important for increasing the level of immersion during the training.

Access to the virtual vasculature is gained through a standard sheath inserted on either the left or right tracking device, the arrangement of which has been designed to match that of the real femoral arteries. This sheath is fixed in place with a small setscrew that applies pressure to a cylindrical plate to evenly apply pressure to the sheath surface without deforming it. Once a real catheter is inserted into the sheath, the simulator starts tracking the instrument's motion.

In an exemplary embodiment, the distance between the two encoders entry access points is approximately 6.25″. As the catheter passes through the encoding unit, it is angled at approximately 10 degrees prior to exiting the encoding section to accurately mimic the angles of the actual arteries in the legs. Passive haptic feedback—friction along the iliac arch—is provided by a set of anatomically correct fluoropolymer tubing phantoms 366a,b. In an exemplary embodiment, the tubing has an outside diameter of 5/16″ and an internal diameter of 3/16″ and is made from Virgin Electrical Grade Teflon® PTFE. These tubes have a complex serpentine shape to match that of the femoral arteries as they bifurcate from the umbilicus. From a vertical plane, this shape is a sinusoidal wave that is contained within a 3.00″ by 3.50″ rectangle. From a horizontal plane, the sine wave is contained within a 3.25″ by 2.75″ rectangle. Due to the flexible nature of the tubing, the exact shape of this phantom is not overly important, however the entrance and termination vectors should be parallel to ensure smooth movement of the instruments.

The exit distance of the encoding devices is 6.00″ in an exemplary embodiment which is also the entry distance between the two phantom tubes. After the s-curve of the phantom tubes 366, they terminate at a distance of 7/16″ from their center points, the normals of which are aligned in parallel to those of their entry vectors. Each tube is held firmly in place with friction from the spring-like compression of the Teflon tubing and has 0.50″ of surround material to provide a firm base to avoid damage during typical use.

Once through the iliac arch, the present simulator then relies on a high-fidelity visualization to provide “visual haptic feedback” to the user throughout the remainder of the training session. The phantom tubes 366 provide the majority of the friction and haptic sensation experience in a real procedure simply, cost-effectively, and without the use of motors, gantries, or the complex arrangements typically implemented in other tracking systems.

In an attempt to contain the complete tracking system within a human-scaled form factor, in an exemplary embodiment a novel method of dealing with the instrument once is passes through the tracking units. Attached to the end of the Teflon femoral phantoms 366 is a horizontal spiral 367 (FIG. 24b) of Teflon tubing which connects both termination points of the phantoms. This allows storage of an instrument inserted through either side of the tracking device to remain in a compact space surrounding the tracking device base and well within a human form constraint 361. In one embodiment, the spiral 367 is constructed from 5/16″ OD Virgin Electrical Grade Teflon® PTFE with an ID of 3/16″ and has 4 revolutions with an OD of approximately 8.00″ before it reenters the opposite side of the device.

Once a catheter or guidewire is inserted into a tracking unit, it passes through a slightly curved channel 362 whose midpoint is directly under the focal plane of the optical sensors 374. This arc can vary in size. In an exemplary embodiment, a diameter of about eleven inches provides adequate pressure without binding the catheter. From end to end, this arc should be approximately three inches long. As shown in FIG. 24f, the channel can have a variety of geometries including generally circular, cam-shaped and the like providing desirable channel properties.

The curved geometry of the channel allows a variation of diameter sizes for the endoluminal devices, as shown in FIGS. 24f. The slightly curved path forces a “predictable” surface contact patch between any instrument inserted and the focusing screen of the sensing unit.

In order to keep the sensing pathway clean and unobstructed, an optically-pure focusing screen separates the catheter or guidewire from the optical encoder. This focusing screen should be 1/64 inch thick and approximately 1.00″W×3.00″ L. This focusing screen can be held in place with either adhesive or with a mechanical system. Adhesives would prevent the glass from breaking due to over tightening. In one embodiment, each entrance and exit to the sensing pathway is conical and free of edges or areas where the tip of the instrument could get snagged or hung up. Because this pathway is smooth and gradual, no modification to the tips of the instruments is necessary. This allows tracking of various endoluminal devices.

The tracking interface in this invention provides enhanced accuracy for tracking catheter and guidewire movement, while relying on a more robust and flexible mechanical operation, and a more cost-effective solution compared to known designs. The accuracy of the tracking device, as well as its ability to track both catheters and guidewires of various sizes ranges from about 0.5 mm to 3.5 mm.

The inventive device 360 for endoluminal tracking can be mounted to a human-scaled torso if desired, as shown in FIG. 24b, providing a more immersive and realistic training environment. The termination of the femoral phantoms coincides with the bifurcation of the iliac arteries at the level of the umbilicus as found on a real patient. Transitioning from surgical practice or training on a simulation system incorporating a tracking device like this is more natural as the user is not forced to learn to “use” the haptic interface, but rather executes the procedure in the usual manner.

Interventional radiology an/or endoscopic simulators can include one or more of the above-described components. Simulators in general should maintain system-wide real-time performance. In addition, to be cost effective, they should use commercial off the shelf, affordable hardware.

An interventional radiology simulator can include one or more of multi-representation vascular anatomical model, catheters and guidewire models based on wire-like deformable structure, therapeutic device models using real-time tubular deformable representation, include a collision detection/collision response component, blood flow computation associated with contrast agent propagation, fluoroscopic rendering, potentially simulation of cardiac and respiratory motion using volume deformation, and a tracking or haptic interface.

A surgical endoscopy simulator may have a slightly different set of components. One difference would come from what anatomy or which devices would be represented using the models described above: multi-representational models, flexible endoscope models with collision detection and collision response, visible light rendering or possibly synthetic fluoroscopic imaging, a tracking device scaled for larger instruments.

Therefore, simulating different procedures would involve mostly modeling the appropriate anatomical structures and the corresponding devices. The first stage relies on the generation of a graph of medial axes and associated cross sections. As described above, a smooth surface and volume representation would then be generated on the basis on the medial axis representation. If a database of medical devices were to be designed to include many flexible instruments such as endoscopes, catheters, guidewires, stents, etc., then a large number of training systems could be developed using the inventive approach, benefiting from consistency, real-time performance and high-fidelity visual and haptic feedback.

One advantage of such a system for medical training stems from the ability to provide realism in a clinical context: physician trainees will learn to recognize anatomic detail and patterns in a manner that most closely resembles what they will encounter in practice. However, the ability of such a design to take the user into a realm where they are otherwise unable to go, to “augment reality” rather than merely reproducing it, allows a more powerful method of learning than has previously been possible, when patients served as teaching materials. Intelligent simulation design allows several solutions to be generated from one design method, allowing these advantages to be shared across several specialties.

Simulation systems should be combined with a medical curriculum to be effective. This can be accomplished by creating a library of pathologically relevant cases, devising a tutorial, and accessing the clinician's performance. A pathology case library can be created through the direct segmentation of relevant patient scans or by modifying a generic model to present a “typical” pathology case. Pathological states such as blockages, aneurysms, polyps, to name a few will be represented. A tutorial describes the key aspects of a procedure such as relevant information to perform a diagnostic and proper therapeutic approach.

A set of performance assessment metrics can be developed that track specific physical parameters in a simulation system—deviation of a device from its optimal path of motion, for example, or force exerted on a structure. Although the specific parameters required for performance assessment of vascular/endoscopic procedures is different from laparoscopic surgery, the same fundamental approach can be used. Once the specific parameters are defined and recorded by the simulation system, they will be compared to an expert database using a measure derived from the Z-score, for example. Such a method has proved successful in discriminating expert from novice performance. Relevant metric parameters would be path length, rotation, tip angle, and tip force. Since a significant part of procedures is cognitive as well as physical, metrics of technical performance might not correlate entirely with the overall performance assessment.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method of representing a network of tubular structures, comprising:
defining a set of medial axes for the tubular structure;
defining a series of cross sections along each medial axis in the set of medial axes;
generating a connectivity graph of the medial axes;
defining multiple surface representations based upon the graph of the medial axes and the cross sections;
computing a volume defined by a first one of the surface representations; and
defining a partition of the medial axis, cross-sections, surface and/or volume representations.

2. The method according to claim 1, wherein the medial axes and cross-sections are generated from patient data.

3. The method according to claim 1, wherein the medial axes and cross-sections are generated from artistic design.

4. The method according to claim 1, wherein the medial axes and cross-sections are generated from mathematical models.

5. The method according to claim 1, wherein the surface representation includes convex and non-convex sets.

6. The method according to claim 1, further including approximating a volume defined by the surface by a set of volume elements to define interior space of the model.

7. A method according to claim 1, further including cross-referencing the partitions of different representations of the tubular structure or lumen.

8. The method according to claim 1, further including assigning properties to the medial axis, cross-sections, surface and/or volume representations.

9. The method according to claim 8, wherein the properties include tissue properties.

10. The method according to claim 8, wherein the properties include contrast agent concentration and contrast agent attenuation coefficient.

11. The method according to claim 1, further including computing propagation of contrast agent concentration based upon discretization of the medial axes.

12. The method according to claim 1, further including computing blood flow based upon a connectivity graph.

13. The method according to claim 1, where a multi-resolution surface representation is derived from the medial axis graph representation and the set of cross sections.

14. The method according to claim 13, further including using branching angle and vessel radii to reduce artifacts when representing the tubular structures.

15. The method according to claim 14, further including joining and/or merging the surface of a branch to another based upon a filet created by end-segment-grouping technique and/or adjacent-quadrant-grouping technique.

16. The method according to claim 13, further including recursive joint tiling to generate a minimally twisted surface representation.

17. The method according to claim 13, further including adaptive cross sections distribution using both radii profile and medial axis curvature profile of each vessel.

18. The method according to claim 1, further including representing global deformation of a network of tubular structures and local deformation of a tubular structure.

19. The method according to claim 18, further including simulating respiratory and cardiac motion using global deformation method based upon a volumetric control lattice controlling the deformation of the graph of medial axes.

20. The according to claim 18, further including simulating local deformation of a tubular structure using a combination of local deformation of the medial axis and deformation of the surface representation.

21. The method according to claim 1, further including computing collision detection for the tubular structure and a device model.

22. The method according to claim 1, further including modeling a flexible device as a finite set of linearly elastic beam elements to cumulatively approximate the non-linear behavior of the device, in a way that enables real-time computation of the deformation.

23. The method according to claim 22, further including computing sub-structure analysis of the flexible device model to further optimize the computation.

24. The method according to claim 22, further including simulating permanent contact between nested device models using a composite representation.

25. The method according to claim 24, wherein the composite representation includes a definition of composite material properties.

26. The method according to claim 24, wherein the composite representation includes a visual representation of the composite model.

27. The method according to claim 22, further including modeling a tubular structure as a flexible medial axis and a flexible surface representation.

28. The method according to claim 27, wherein the flexible medial axis is defined as a finite set of linearly elastic beam elements and the flexible surface representation contains surface elements and collidable points.

29. The method according to claim 27, further including modeling the deformation of the surface representation as a radial deformation.

30. The method according to claim 22, wherein the device model is enclosed within the tubular anatomical model.

31. The method according to claim 1, further including detecting collisions within a partition of the tubular structure and elements of a flexible device model; collision detection including
defining a subset of partitions potentially containing a particular device element,
determining within the subset of partitions which partition the device element now resides in;
determining whether the device element is outside or inside the surface representation of the partition.

32. The method according to claim 31, further including simulating collision response between the device model and the anatomy model based upon convex set partitioning.

33. The method according to claim 32, further including simulating collision response using an iterative process taking into account the mechanical coupling between the elements of the flexible device.

34. The method according to claim 30, further including simulating a medical procedure having navigation or deployment of the device within the anatomy.

35. The method according to claim 34, further including modeling deformation of the flexible device and corresponding deformation in the tubular structure.

36. The method according to claim 35, further including blood flow changes due to deformation of the tubular structure model.

37. The method according to claim 34, wherein the medical procedure includes an interventional radiology procedure.

38. The method according to claim 34, wherein the medical procedure includes a surgical endoscopic procedure.

39. The method according to claim 1, further including generating information for display to a user from computation, deformation, and navigation of a virtual device within the tubular structure.

40. The method according to claim 39, wherein the user navigates the virtual device via a control portion of an actual device corresponding to the control portion of the virtual device.

41. The method according to claim 39, further including providing visual feedback to the user for a simulated medical procedure.

42. The method according to claim 39, further including providing haptic feedback to the user for a simulated medical procedure.

43. The method according to claim 41, wherein the visual feedback includes visible light rendering of the model and the virtual device.

44. The method according to claim 41, wherein the visual feedback includes simulated X-ray processing from volumetric datasets of medical images.

45. The method according to claim 44, further including generating synthetic X-ray images directly from Computed Tomography datasets.

46. A method of providing visual feedback for a simulated medical procedure, comprising:
generating a synthetic X-ray rendering from volumetric datasets;
processing the volumetric dataset to determine attenuation coefficients from voxel values as intensity values in the volumetric datasets;
using volume rendering techniques for simulating X-ray images;
using 2D and/or 3D texture mapping techniques to implement volume rendering in real-time; and
computing an approximation of the X-ray attenuation process using blending operations on series of planes defined through the volumetric texture.

47. The method according to claim 46, further including combining a synthetic X-ray image and a three-dimensional model of a network of tubular structures using visible light rendering.

48. The method according to claim 46, further including generating a real-time simulation of a three-dimensional angiography.

49. The method according to claim 46, further including simulating contrast agent propagation.

50. The method according to claim 49, further including simulating contrast agent propagation in the anatomical model based upon an advection-diffusion model.

51. The method according to claim 49, wherein one-dimensional contrast agent concentration values are mapped to a volumetric representation of a network of tubular structures.

52. A tracking device, comprising
a non-contact array of optical sensors comprising:
a series of optical encoders;
a curved pathway between the medical device and the sensor focal point to allow a multiplicity of different sized medical devices to be tracked;
a series of tracking devices are used to track multiple coaxial medical devices;
wherein contact between the encoding device and the instrument being tracked is prevented.

53. A tracking device according to claim 52, wherein the optical encoding device uses visible light to interpret motion.

54. A tracking device according to claim 52, wherein the optical encoding device uses infrared light to interpret motion.

55. A tracking device according to claim 52, wherein the optical encoding device uses laser light to interpret motion.

56. A tracking device according to claim 52, wherein multiple tracking devices are arrayed to permit tracking of several medical devices simultaneously.

57. A tracking device according to claim 52, wherein the internal nested instrument is tracked from the proximal end of the outer medical device

58. A tracking device according to claim 52, wherein the position of the medical device is maintained within the focal zone of the encoder by means of a curved channel.

59. A tracking device according to claim 52, wherein a multiplicity of tracking devices is used to permit entry to either the right or left side of the simulated body.

60. A tracking device according to claim 52, wherein the tracking device includes sensors to detect motion in both translation and rotation of the surface of the medical device.

61. A tracking device according to claim 52, wherein the tracking device is integrated into and contained within the training system.

62. A tracking device according to claim 52, wherein haptic feedback representing the network of tubular structures is provided by passive anatomically approximated containment channels which replicate the anatomic contour of the body part at which interaction occurs.

63. A tracking device according to claim 52, wherein the inserted part of the medical device is contained within the mannequin form in a shape that reduces friction and other non-anatomic effects from acting on the medical device.

64. A tracking device according to claim 52, wherein the sensing system can be adopted to allow tracking of other flexible instruments such as endoscopes.

65. A system for simulating interventional radiology procedures, comprising:
a module to generate multiple representations of a network of tubular structures with geometric, material, mathematical properties to different representations;
a deformation module to compute global and local deformation of the network of tubular structures;
a collision detection module to compute collision detection between the tubular structure and a device model with a series of nodes.

66. The system according to claim 65, further including a module to model and a module to render one or more flexible diagnostic devices and the navigation in the network of tubular structures.

67. The system according to claim 66, wherein the deformation of the devices is based upon a finite set of connected elements in real-time.

68. The system according to claim 65, further including a module to simulate fluid/blood flow.

69. The system according to claim 68, further including determining fluid/blood flow changes due to the deformation of a network of tubular structures.

70. The system according to claim 65, further including a contrast propagation module to simulate propagation of concentration distribution of fluid mixture in a network of tubular structures based upon advection-diffusion.

71. The system according to claim 65, further including a module to simulate fluoroscopy and generate synthetic X-images directly from volumetric datasets in real-time.

72. The system according to claim 65, further including a tracking device to track one or multiple endoluminal instrument.

73. The system according to claim 72, wherein the tracking device is attachable to a human-sized torso model.

74. A method of simulating interventional radiology procedures, comprising
defining a set of medial axes for a tubular structure representing anatomy;
defining a series of cross sections along each medial axis in the set of medial axes;
generating a connectivity graph of the medial axes;
defining multiple surface representations based upon the graph of the medial axes and the cross sections;
computing a volume defined by a first one of the surface representations; and
defining a partition of the medial axis, cross-sections, surface and/or volume representations;
providing visual feedback to a user for a medical procedure simulated using the tubular network.

75. The method according to claim 74, further including representing global and local deformation of a network of tubular structures.

76. The method according to claim 74, further including detecting collisions between the tubular structure and a modeled device within the tubular network.

77. The method according to claim 74, further including modeling and rendering one or multiple flexible diagnostic device(s) and the navigation in a network of tubular structures and the permanent contact among multiple device(s) and the deformation of these devices based upon a finite set of connected elements in real-time;

78. The method according to claim 74, further including modeling and rendering one or multiple flexible therapeutic device(s) and the deformation of these devices based upon a finite set of connected elements and flexible surface using radial deformation in real-time.

79. The method according to claim 74, further including simulating fluid/blood flow and further including simulating the fluid/blood flow changes due to the deformation of a network of tubular structures.

80. The method according to claim 74, further including simulating and rendering the propagation of a concentration distribution of fluid mixture in a network of tubular structures based upon advection-diffusion equation in real-time.

81. The method according to claim 74, further including simulating and rendering the fluoroscopy and synthetic X-images directly from (CT) volumetric datasets in real-time.

82. The method according to claim 74, further including tracking the position of one or multiple endoluminal instruments.
